(19) United States
(12) Patent Application Publication
(10) Pub. No.: US 2026/0079425 A1
(43) Pub. Date: Mar. 19, 2026

(54) CARTRIDGE

(71) Applicant: CANON KABUSHIKI KAISHA, Tokyo (JP)

(72) Inventors: AKINORI MITSUMATA, Tokyo (JP); NORITOMO YAMAGUCHI, Kanagawa (JP)

(21) Appl. No.: 19/324,358

(22) Filed: Sep. 10, 2025

(30) Foreign Application Priority Data
Sep. 13, 2024 (JP) 2024-159138

(51) Int. Cl. G03G 15/08

(52) U.S. Cl. CPC G03G 15/0881; G03G 15/0875

(57) ABSTRACT

A cartridge includes a first chamber for storing toner, a second chamber provided to be aligned with the first chamber in a first direction, a filter provided to divide the first chamber and the second chamber, the filter allowing passage of air and restricting passage of the toner, a discharge port for discharging the toner stored in the first chamber to the outside of the cartridge, an intake port for introducing air into the second chamber from an outside of the cartridge, and a discharge pipe portion for communicating the discharge port with an inside of the first chamber, wherein the discharge port is provided on a first end surface, which is an end surface of the cartridge in the first direction, and the intake port is provided on a second end surface, which is an end surface of the cartridge in a second direction intersecting the first direction.

### BACKGROUND

### Field of the Technology

The present disclosure relates to a cartridge.

### Description of the Related Art

Generally, electrophotographic image forming apparatuses form images by transferring a toner image formed on a surface of a photosensitive drum to a transfer material serving as a transfer medium. In addition, as developer supply methods, for example, a process cartridge method and a toner supply method are known. A process cartridge method is a method of integrating a photosensitive drum and a developing container into a process cartridge and replacing the process cartridge with a new one when a developer runs out.

On the other hand, a toner supply method is a method of supplying new toner to a developing container when toner runs out. In the related art, an image forming apparatus that uses a toner pack that is attachable to and detachable from a developing container to supply toner to the developing container has been proposed (see Japanese Patent Application Publication No. 2020-154300).

Also, an image forming apparatus including a developing device that stores toner, a toner storage container that stores the toner supplied to the developing device, and an air pump that sends air to the toner storage container has been proposed (see Japanese Patent Application Publication No. 2000-147884). This image forming apparatus is provided with an air filter that allows only the air out of the toner and the air sent from the toner storage container to the developing device to be ventilated to the outside of the developing device.

### SUMMARY

The present disclosure is directed to provide a cartridge.

The cartridge of the present disclosure includes the following.
a first chamber configured to store toner;
a second chamber provided to be aligned with the first chamber in a first direction;
a filter provided to divide the first chamber and the second chamber, the filter allowing passage of air and restricting passage of the toner;
a discharge port configured to discharge the toner stored in the first chamber outside of the cartridge;
an intake port configured to introduce air into the second chamber from outside of the cartridge; and
a discharge pipe portion configured to allow communication between the discharge port and an inside of the first chamber,
wherein the discharge port is provided on a first end surface, which is an end surface of the cartridge in the first direction, and
the intake port is provided on a second end surface, which is an end surface of the cartridge in a second direction intersecting the first direction.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram showing an overall image forming apparatus according to Example 1;

FIG. 2A is a perspective view showing the image forming apparatus;

FIG. 2B is a perspective view showing the image forming apparatus with a front door open;

FIG. 2C is a perspective view showing the image forming apparatus with a toner cartridge removed;

FIG. 3A is a perspective view showing an image forming unit;

FIG. 3B is a perspective view showing the image forming unit with the toner cartridge removed;

FIG. 4 is a perspective view showing an optical path of laser light emitted from a laser scanner;

FIG. 5A is a plan view showing the laser scanner and the image forming unit;

FIG. 5B is a plan view showing the image forming unit;

FIG. 6A is a cross-sectional view showing a cross-section along line 6A-6A in FIG. 5B;

FIG. 6B is a cross-sectional view showing a cross-section along line 6B-6B in FIG. 5B;

FIG. 7 is a cross-sectional view showing a cross-section along line 7A-7A in FIG. 5A;

FIG. 8 is a perspective view showing a state in which the image forming unit is pulled out from an apparatus main body;

FIG. 9A is a front view showing the toner cartridge;

FIG. 9B is a top view showing the toner cartridge;

FIG. 9C is a bottom view showing the toner cartridge;

FIG. 9D is a side view showing the toner cartridge;

FIG. 9E is a rear view showing the toner cartridge;

FIG. 10A is a cross-sectional view showing a cross-section along line 10A-10A in FIG. 9B;

FIG. 10B is a perspective view of FIG. 10A;

FIG. 10C is an exploded view of FIG. 10A;

FIG. 10D is an exploded perspective view showing the toner cartridge;

FIG. 11 is a diagram showing a joint part between a first frame and a second frame;

FIG. 12A is a cross-sectional view showing a cross-section along line 12A-12A in FIG. 9E and showing a discharge pipe;

FIG. 12B is a perspective view of FIG. 12A;

FIG. 13A is a partial enlarged view showing a state in which the toner cartridge is removed from the apparatus main body;

FIG. 13B is a partial enlarged view showing a state in which the toner cartridge is attached to the apparatus main body;

FIG. 14A is a top view of a toner cartridge of Example 2;

FIG. 14B is a cross-sectional view showing a cross-section along line 14B-14B in FIG. 14A;

FIG. 14C is a perspective view of FIG. 14B; and

FIG. 14D is an exploded perspective view of FIG. 14B.

### DESCRIPTION OF THE EMBODIMENTS

### Example 1

### Overall Configuration

First, Example 1 of the present disclosure will be described. An image forming apparatus 1 according to Example 1 is an electrophotographic laser beam printer. Also, it is assumed that the image forming apparatus includes a printer, a copier, a facsimile, and a multifunction machine, and indicates an apparatus that forms an image on a sheet used as a recording medium on the basis of image information input from an external PC or image information read from a document. Further, in addition to a main body having an image forming function, the image forming apparatus may be connected to auxiliary devices such as an optional feeder, an image reading device, and a sheet processing device, but the entire system connected to such auxiliary devices is also a type of image forming apparatus.

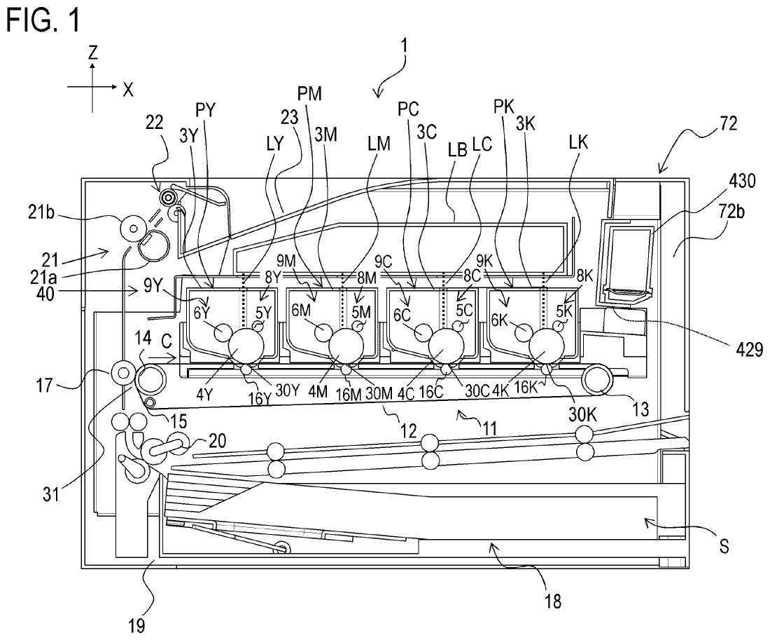

As shown in FIG. 1, the image forming apparatus 1 has an image forming portion 40 that forms an image on a sheet S, a feeding unit 18, a fixing unit 21, and a pair of discharge rollers 22. The image forming portion 40 includes four process cartridges PY, PM, PC, and PK that form toner images of four colors, yellow (Y), magenta (M), cyan (C), and black (K), respectively, and a laser scanner LB. The laser scanner LB is disposed above the process cartridges PY, PM, PC, and PK. Also, an LED exposure unit may be used in place of the laser scanner LB.

Also, a part of the image forming apparatus 1 excluding each of the process cartridges PY, PM, PC, and PK and toner cartridges 430Y, 430M, 430C, and 430K, which will be described later, may be referred to as a main body of the image forming apparatus 1 or an apparatus main body 72. In addition, in the following description, the toner cartridges 430Y, 430M, 430C, and 430K may be simply referred to as cartridges 430Y, 430M, 430C, and 430K. The process cartridges PY, PM, PC, and PK may be removably supported relative to the apparatus main body 72, or may be unremovably fixed to the apparatus main body 72.

In Example 1, reference signs of components corresponding to each of yellow, magenta, cyan, and black toner are suffixed with Y, M, C, and K. Configurations and operations of the components with these suffixes are substantially the same except for different toner colors. Accordingly, in the following, unless a particular distinction is required, the suffixes Y to K may be omitted and a general description may be given.

Also, in the following description, unless otherwise specified, it is assumed that the process cartridges PY, PM, PC, and PK and the toner cartridges 430Y, 430M, 430C, and 430K are in their normal positions, that is, positions when they are attached to the apparatus main body 72 (attached positions). Further, directions X, Y, and Z are defined as follows.

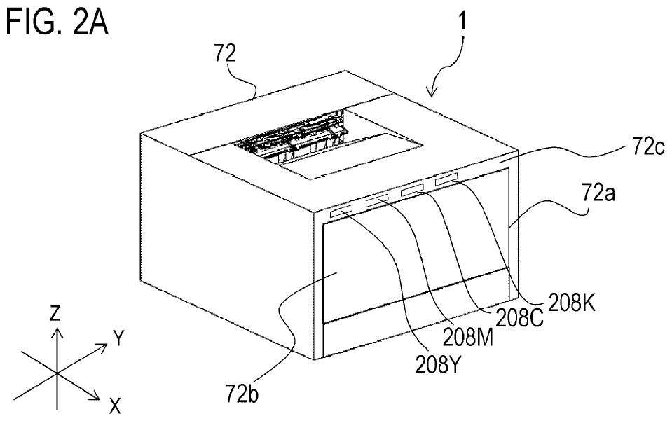

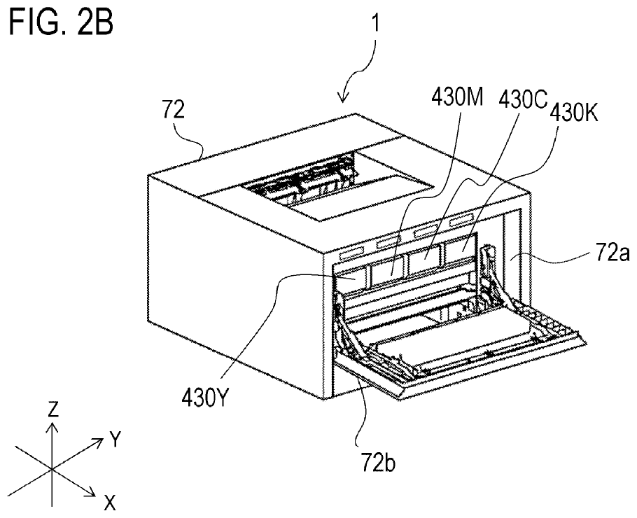

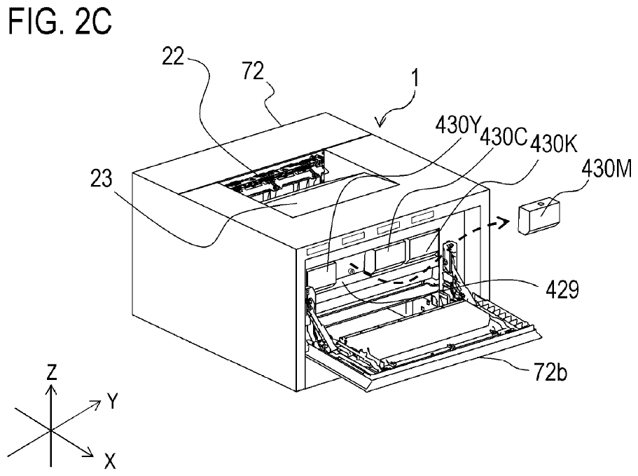

As shown in FIG. 2A, a front to rear direction is indicated by an X axis, and a direction from a back surface to a front surface of the image forming apparatus 1 is indicated by an X direction. The X direction may be referred to as a forward direction or a direction toward the front. Further, a downstream side in the X direction of the image forming apparatus 1 may be referred to as a front side (forward side) and an upstream side thereof may be referred to as a back side. In the figures, the front side is indicated by reference sign FE, and the rear side by reference sign BE.

A left to right direction is indicated by a Y axis, and a direction from a left side to a right side of the image forming apparatus 1 is indicated by a Y direction. The Y direction may be referred to as a right direction. Further, a downstream side in the Y direction of the image forming apparatus 1 may be referred to as a right side, and an upstream side thereof may be referred to as a left side. In the figures, the right side is indicated by reference sign RE, and the left side is indicated by reference sign LE.

A vertical direction is indicated by a Z axis, and a direction from a lower side to an upper side of the image forming apparatus 1 is indicated by a Z direction. The Z direction may be referred to as an upward direction, a height direction, or a vertical direction. Further, a downstream side in the Z direction of the image forming apparatus 1 may be referred to as an upper side, an upper surface side, or a top surface side, and an upstream side thereof may be referred to as a lower side, a lower surface side, or a bottom surface side.

The X axis, Y axis, and Z axis are perpendicular to each other. For example, the X axis is perpendicular to the Y axis and also perpendicular to the Z axis. Also, a plane perpendicular to the X axis may be referred to as a YZ plane, a plane perpendicular to the Y axis may be referred to as a ZX plane, and a plane perpendicular to the Z axis may be referred to as an XY plane. For example, the XY plane is a horizontal plane. The X and Y directions are directions along the horizontal XY plane, that is, horizontal directions.

The process cartridge PY has a drum unit 8Y and a developing unit 9Y. The drum unit 8Y has a photosensitive drum 4Y and a charging roller 5Y. The photosensitive drum 4Y is formed by applying an organic photoconductive layer to an outer periphery of an aluminum cylinder and is rotated by a drive motor (not shown). Also, a photosensitive belt may be used in place of the photosensitive drum 4Y. The developing unit 9Y has a developing container 3Y that stores the yellow toner, and a developing roller 6Y that develops an electrostatic latent image on the photosensitive drum 4Y.

Similarly, the process cartridge PM has a drum unit 8M and a developing unit 9M. The drum unit 8M has a photosensitive drum 4M and a charging roller 5M. The photosensitive drum 4M is formed by applying an organic photoconductive layer to an outer periphery of an aluminum cylinder and is rotated by a drive motor (not shown). Also, a photosensitive belt may be used in place of the photosensitive drum 4M. The developing unit 9M has a developing container 3M that stores the magenta toner, and a developing roller 6M that develops an electrostatic latent image on the photosensitive drum 4M.

Also, the process cartridge PC has a drum unit 8C and a developing unit 9C. The drum unit 8C has a photosensitive drum 4C and a charging roller 5C. The photosensitive drum 4C is formed by applying an organic photoconductive layer to an outer periphery of an aluminum cylinder and is rotated by a drive motor (not shown). A photosensitive belt may be used in place of the photosensitive drum 4C. The developing unit 9C has a developing container 3C that stores the cyan toner, and a developing roller 6C that develops an electrostatic latent image on the photosensitive drum 4C.

Also, the process cartridge PK has a drum unit 8K and a developing unit 9K. The drum unit 8K has a photosensitive drum 4K and a charging roller 5K. The photosensitive drum 4K is constructed by applying an organic photoconductive layer to the outer periphery of an aluminum cylinder, and is rotated by a drive motor (not shown). A photosensitive belt may be used in place of the photosensitive drum 4K. The developing unit 9K has a developing container 3K that stores the black toner, and a developing roller 6K that develops an electrostatic latent image on the photosensitive drum 4K.

These four process cartridges PY, PM, PC, and PK are disposed side by side in the X direction. Also, the image forming portion 40 is provided with an intermediate transfer belt unit 11 disposed below the process cartridges PY, PM, PC, and PK. The intermediate transfer belt unit 11 has an intermediate transfer belt 12 wound around a drive roller 14, a tension roller 13, and an assist roller 15, and a secondary transfer roller 17. The intermediate transfer belt 12 is rotated by the drive roller 14 in the clockwise direction indicated by arrow C in FIG. 1. Primary transfer rollers 16Y, 16M, 16C, and 16K are provided inside the intermediate transfer belt 12.

The primary transfer rollers 16Y, 16M, 16C, and 16K form primary transfer portions 30Y, 30M, 30C, and 30K with the photosensitive drums 4Y, 4M, 4C, and 4K, respectively. The secondary transfer roller 17 is disposed to face the drive roller 14 via the intermediate transfer belt 12. The secondary transfer roller 17 and the intermediate transfer belt 12 are in contact with each other to form a secondary transfer portion 31.

The fixing unit 21 has a fixing film 21a heated by a heater, and a pressure roller 21b brought into pressure contact with the fixing film 21a. The feeding unit 18 is provided at a lower portion of the image forming apparatus 1. The feeding unit 18 includes a feeding cassette 19 that can be pulled out from and attached to the apparatus main body 72, and a feeding roller 20 that feeds the sheet S stored in the feeding cassette 19. Also, the feeding unit 18 has a manual feeding port into which the sheet is manually inserted. Further, the sheet includes paper such as blanks and envelopes, plastic films such as overhead projector sheets (OHP), and fabrics.

### Image Forming Operation

Next, an image forming operation of the image forming apparatus 1 configured as above will be described. When an image signal is input to the laser scanner LB from a personal computer (not shown) or the like, laser beams LY, LM, LC, and LK corresponding to image signals are radiated from the laser scanner LB onto the photosensitive drums 4Y, 4M, 4C, and 4K.

In this case, a surface of the photosensitive drum 4Y is uniformly charged to a predetermined polarity and potential by the charging roller 5Y in advance, and an electrostatic latent image is formed on the surface by being irradiated with the laser beam LY from the laser scanner LB. The electrostatic latent image formed on the photosensitive drum 4Y is developed by the developing roller 6Y, and a yellow (Y) toner image is formed on the photosensitive drum 4Y.

In the same way, magenta (M), cyan (C), and black (K) toner images are formed on the photosensitive drums 4M, 4C, and 4K. The respective color toner images formed on the respective photosensitive drums are transferred to the intermediate transfer belt 12 by the primary transfer rollers 16Y, 16M, 16C, and 16K, and are conveyed to the secondary transfer roller 17 by the intermediate transfer belt 12 rotated by the drive roller 14.

Also, the image forming process for each color is performed at the timing of superposition on an upstream toner image primarily transferred onto the intermediate transfer belt 12. After the respective color toner images have been transferred to the intermediate transfer belt 12, the remaining toner on surfaces of the respective photosensitive drums is removed by a cleaning device (not shown).

In parallel with this image forming process, the sheet S stored in the feeding cassette 19 of the feeding unit 18 or the sheet supplied from the manual feeding port is conveyed toward the secondary transfer portion 31. In the secondary transfer portion 31, the full-color toner image on the intermediate transfer belt 12 is transferred to the sheet S by a secondary transfer bias applied to the secondary transfer roller 17. The sheet S onto which the toner image has been transferred is subjected to a predetermined heat and pressure by the fixing film 21a and the pressure roller 21b of the fixing unit 21, and the toner is melted and solidified (fixed). The sheet S that has passed through the fixing unit 21 is discharged in a direction following the X direction by the pair of discharge rollers 22, and is stacked on a discharge tray 23 provided at an upper portion of the apparatus main body 72.

### Schematic Configuration of Toner Cartridge

Next, a schematic configuration of the toner cartridges 430Y, 430M, 430C, and 430K will be described with reference to FIGS. 2A to 2C. FIG. 2A is a perspective view showing the image forming apparatus 1, FIG. 2B is a perspective view showing the image forming apparatus 1 with a front door 72b open, FIG. 2C is a perspective view showing the image forming apparatus 1 with the toner cartridge 430M removed.

As shown in FIG. 2A, the image forming apparatus 1 has the front door 72b supported be openable and closable relative to a housing of the apparatus main body 72. As shown in FIG. 2A, when the front door 72b is in a closed position, it covers an opening 72a provided at a front portion of the apparatus main body 72, that is, a downstream end portion thereof in the X direction. Also, as shown in FIG. 2B, when the front door 72b is in an open position, it opens the opening 72a of the apparatus main body 72. The front door 72b can maintain its position in the open position.

As shown in FIG. 2B, when the front door 72b is opened from the closed position to the open position, the toner cartridges 430Y, 430M, 430C, and 430K are exposed to the outside of the image forming apparatus 1 via the opening 72a. For this reason, a user can access the toner cartridges 430Y, 430M, 430C, and 430K. The toner cartridges 430Y, 430M, 430C, and 430K can supply the toner to the developing containers 3Y, 3M, 3C, 3K of the process cartridges PY, PM, PC, and PK.

The toner cartridges 430Y, 430M, 430C, and 430K are disposed on the downstream side in the X direction and the downstream side in the Z direction of the apparatus main body 72, that is, on the front side and the upper side of the apparatus main body 72. In other words, the toner cartridges 430Y, 430M, 430C, and 430K are disposed on the downstream side of the apparatus main body 72 in a sheet discharging direction of the pair of discharge rollers 22. Also, the toner cartridges 430Y, 430M, 430C, and 430K are disposed side by side in the Y direction. That is, the X direction in which the process cartridges PY, PM, PC, and PK are arranged and the Y direction in which the toner cartridges 430Y, 430M, 430C, and 430K are arranged intersect each other.

As shown in FIG. 2C, the toner cartridges 430Y, 430M, 430C, and 430K are supported removably in the X direction with respect to a cartridge holder 429 provided in the apparatus main body 72. For this reason, without removing the process cartridges PY, PM, PC, and PK from the apparatus main body 72, the toner cartridges 430Y, 430M, 430C, and 430K can be replaced. Since the toner cartridges 430Y, 430M, 430C, and 430K are disposed on the front side of the apparatus main body 72 and exposed by opening the front door 72b, they can be easily replaced.

The cartridge holder 429 is disposed on the front side of the apparatus main body 72 and downstream side of the process cartridges PY, PM, PC, and PK in the X direction. For this reason, even when the toner cartridges 430Y, 430M, 430C, and 430K are removed from the cartridge holder 429, the process cartridges PY, PM, PC, and PK are covered by the cartridge holder 429. Thus, they are not exposed to the outside of the image forming apparatus 1 through the opening 72a. The toner cartridges 430Y, 430M, 430C, and 430K are stored in the apparatus main body 72 with the front door 72b located in the closed position.

Also, as shown in FIG. 2A, indicators 208Y, 208M, 208C, and 208K are provided on a front surface 72c of the apparatus main body 72. These indicators 208Y, 208M, 208C, and 208K are intended to clearly show the user colors of the toner contained in the toner cartridges 430Y, 430M, 430C, and 430K. The indicators 208Y, 208M, 208C, and 208K are configured with LEDs, stickers, or the like, and for example, the indicator 208Y is configured with an LED that lights up or flashes yellow, or a sticker colored yellow. Further, the indicators 208Y, 208M, 208C, and 208K may have a function of displaying a remaining amount of toner stored in the corresponding process cartridges PY, PM, PC, and PK.

Also, in Example 1, the indicators 208Y, 208M, 208C, and 208K are provided on the front surface 72c of the apparatus main body 72 and are not covered by the front door 72b located in the closed position. That is, the indicators 208Y, 208M, 208C, and 208K are exposed to the outside of the image forming apparatus 1 regardless of the position of the front door 72b. However, for example, the indicators 208Y, 208M, 208C, and 208K may be disposed to be covered by the front door 72b located in the closed position and exposed to the outside by opening the front door 72b.

### Image Forming Unit

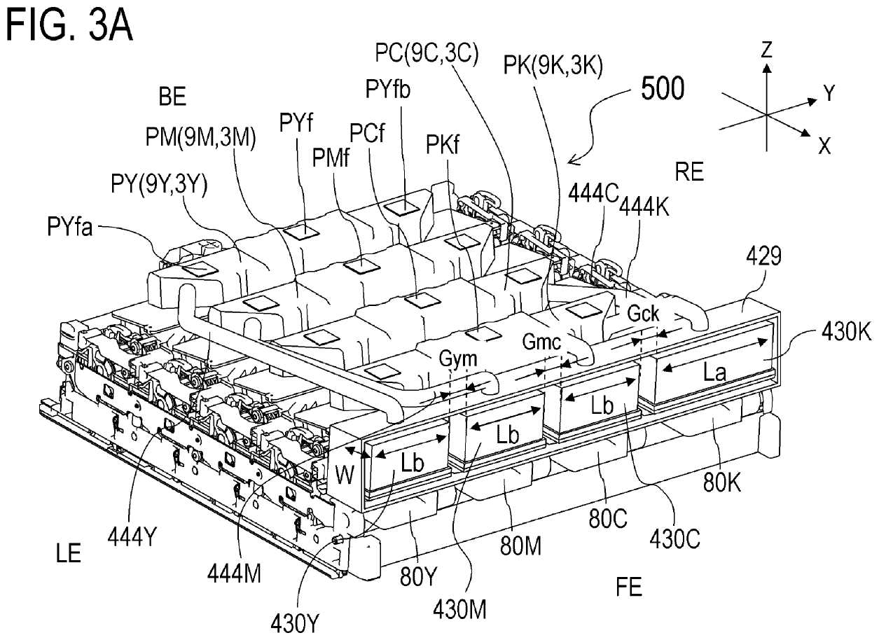

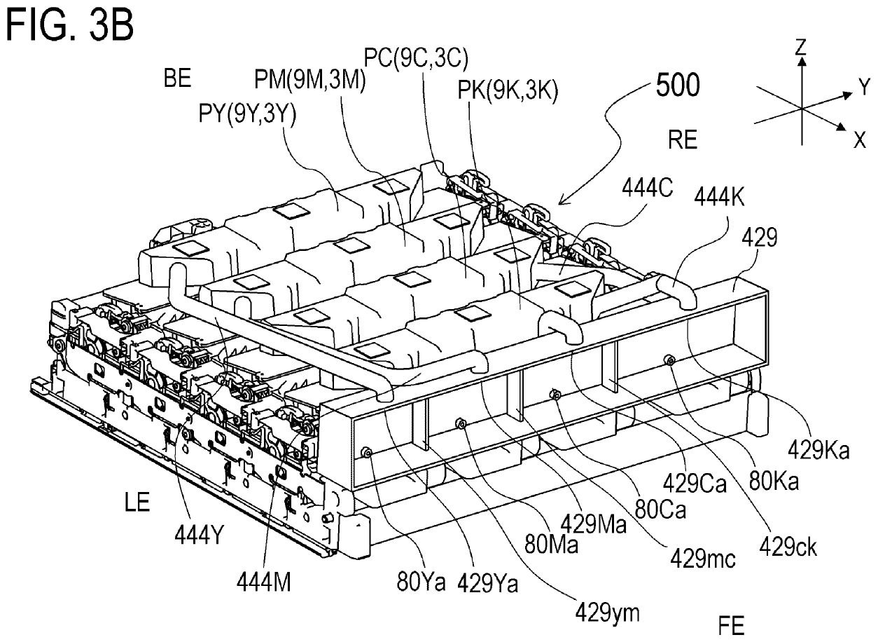

Next, with reference to FIGS. 3A and 3B to 8, an image forming unit 500 including a toner convey mechanism for conveying the toner from the toner cartridges 430Y, 430M, 430C, and 430K to the process cartridges PY, PM, PC, and PK will be described. FIG. 3A is a perspective view showing the image forming unit 500, and FIG. 3B is a perspective view showing the image forming unit 500 with the toner cartridges 430Y, 430M, 430C, and 430K removed.

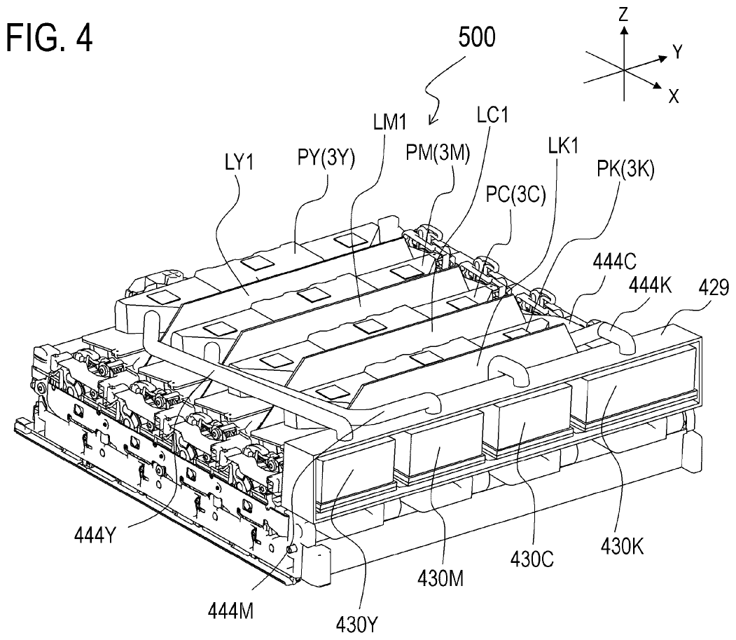

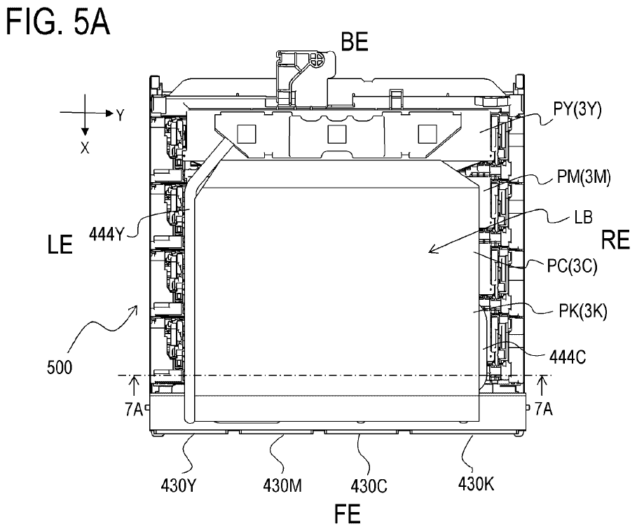

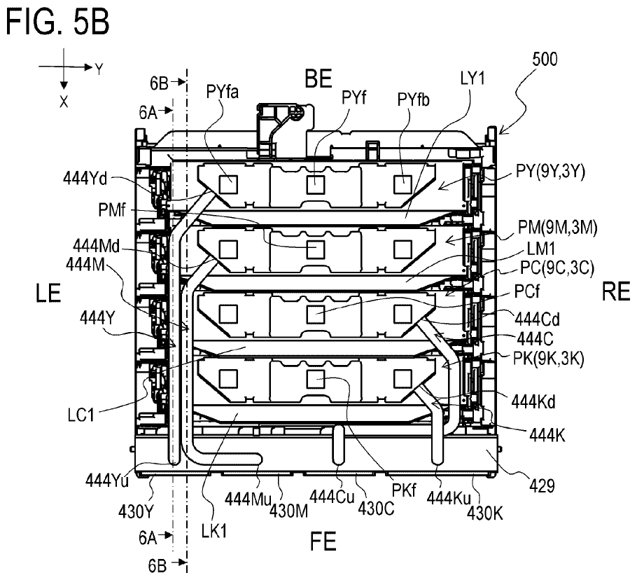

FIG. 4 is a perspective view showing optical paths LY1, LM1, LC1, and LK1 of the laser beams LY, LM, LC, and LK radiated from the laser scanner LB. Also, in FIGS. 4, 5B, and 7, the optical paths LY1, LM1, LC1, and LK1 are visualized for convenience. FIG. 5A is a plan view showing the laser scanner LB and the image forming unit 500, and FIG. 5B is a plan view showing the image forming unit 500.

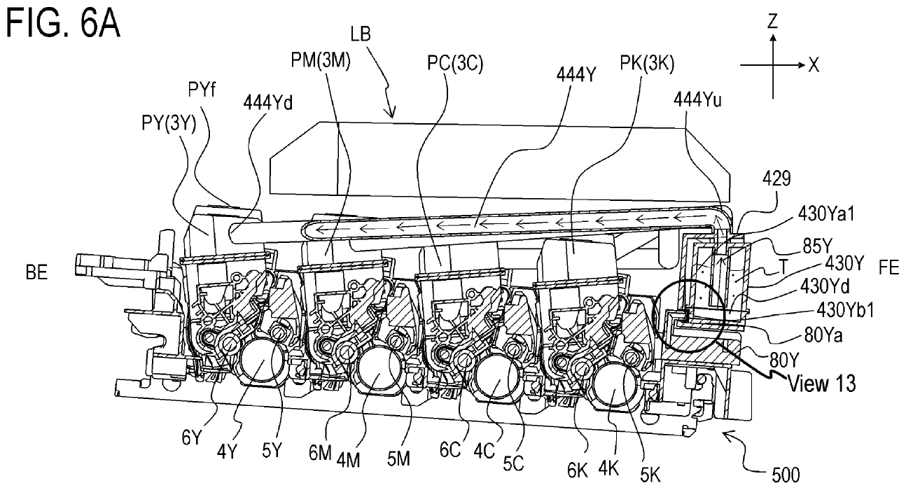

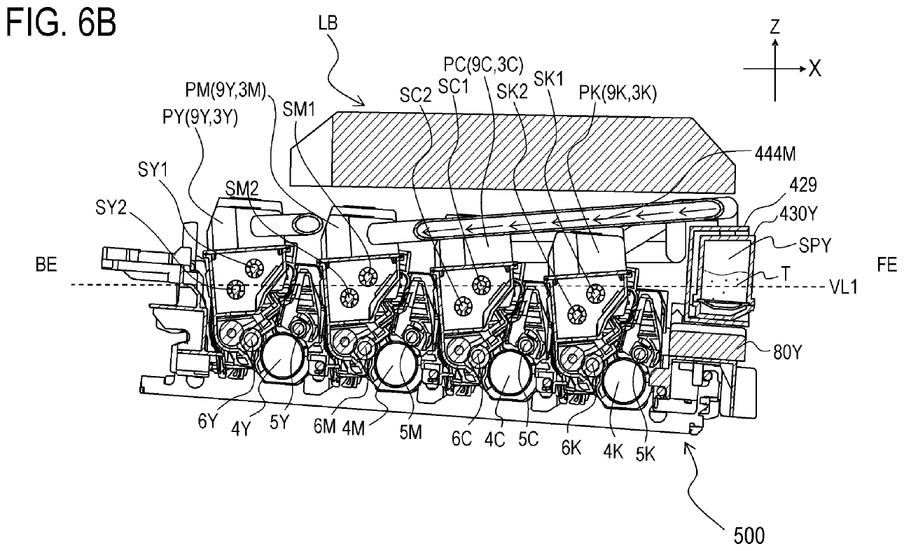

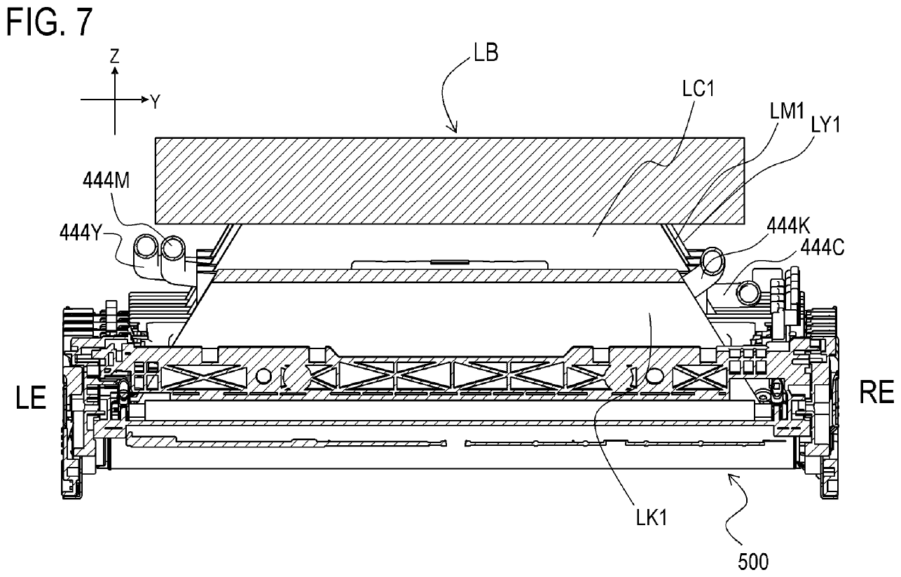

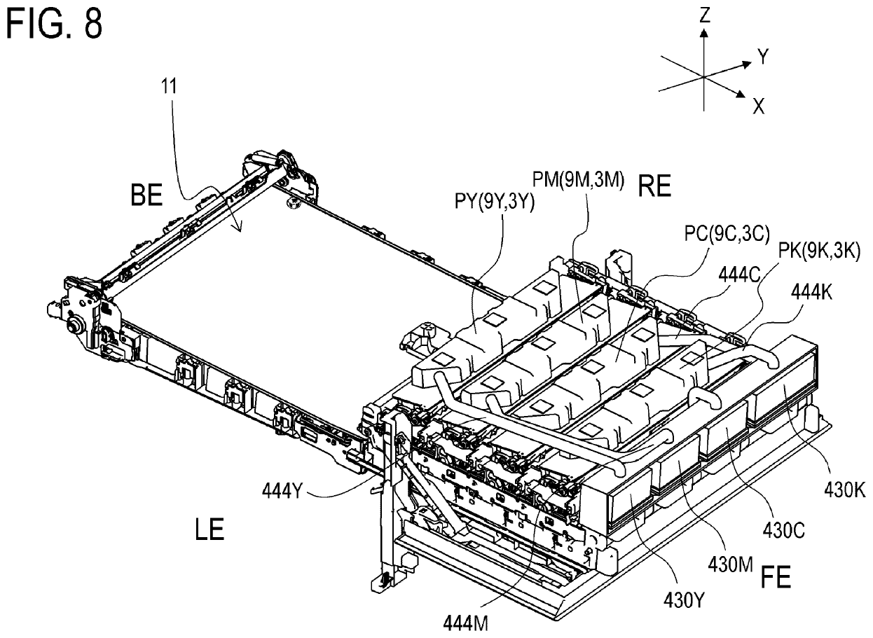

FIG. 6A is a cross-sectional view showing a cross-section along line 6A-6A in FIG. 5B, and FIG. 6B is a cross-sectional view showing a cross-section along line 6B-6B in FIG. 5B. FIG. 7 is a cross-sectional view showing a cross-section along line 7A-7A in FIG. 5A. FIG. 8 is a perspective view showing a state in which the image forming unit 500 is pulled out from the apparatus main body 72.

As shown in FIGS. 3A and 4, the image forming unit 500 has the process cartridges PY, PM, PC, and PK and the toner cartridges 430Y, 430M, 430C, and 430K. Also, the image forming unit 500 has the cartridge holder 429 and pump units 80Y, 80M, 80C, and 80K. The pump units 80Y, 80M, 80C, and 80K are disposed below the cartridge holder 429 and disposed side by side in the Y direction. The pump units 80Y, 80M, 80C, and 80K are configured of positive displacement pumps such as reciprocating pumps or rotary pumps, but are not limited to these. For example, the pump units 80Y, 80M, 80C, and 80K may be non-positive displacement pumps such as centrifugal pumps, propeller pumps, or viscous pumps.

The reciprocating pump is a pump that performs suction and discharge by a reciprocating motion of a piston, a plunger, or the like, and includes a piston pump, a plunger pump, a diaphragm pump, and the like. The rotary pump is a pump that sucks and discharges air by rotating a gear or rotor, and includes a gear pump, a screw pump, a vane pump, and the like. Also, the four pump units 80Y, 80M, 80C, and 80K may be configured as one pump unit or as two or three pump units. In addition, in Example 1, the pump units 80Y, 80M, 80C, and 80K are provided in the apparatus main body 72, but may be respectively provided in the toner cartridges 430Y, 430M, 430C, and 430K.

As shown in FIG. 3B, the pump units 80Y, 80M, 80C, and 80K have discharge ports 80Ya, 80Ma, 80Ca, and 80Ka from which air is discharged. These discharge ports 80Ya, 80Ma, 80Ca, and 80Ka open forward, that is, in the X direction.

The cartridge holder 429 is provided with openings facing the discharge ports 80Ya, 80Ma, 80Ca, and 80Ka , respectively, and intake ports 429Ya, 429Ma, 429Ca, and 429Ka. The openings are provided on a back surface of the cartridge holder 429, and the intake ports 429Ya, 429Ma, 429Ca, and 429Ka are through holes provided on an upper surface of the cartridge holder 429. Since an opening direction of the intake ports 429Ya, 429Ma, 429Ca, and 429Ka is Z direction, it intersects the X direction, which is an opening directions of the discharge ports 80Ya, 80Ma, 80Ca, and 80Ka.

It is assumed that the toner cartridges 430Y, 430M, 430C, and 430K are attached to the cartridge holder 429. In this case, the air discharged from the discharge ports 80Ya, 80Ma, 80Ca, and 80Ka is supplied to the inside of the toner cartridges 430Y, 430M, 430C, and 430K. The toner is discharged from the toner cartridges 430Y, 430M, 430C, and 430K together with air. The discharged toner is received by supply pipes 444Y, 444M, 444C, and 444K via the intake ports 429Ya, 429Ma, 429Ca, and 429Ka of the cartridge holder 429.

The supply pipes 444Y, 444M, 444C, and 444K have upstream end portions 444Yu, 444Mu, 444Cu, and 444Ku connected to the intake ports 429Ya, 429Ma, 429Ca, and 429Ka, respectively. Also, the supply pipes 444Y, 444M, 444C, and 444K have downstream end portions 444Yd, 444Md, 444Cd, and 444Kd connected to the developing containers 3Y, 3M, 3C, and 3K, respectively.

In addition, the toner discharged together with the air from the toner cartridges 430Y, 430M, 430C, and 430K is supplied to the developing containers 3Y, 3M, 3C, and 3K through the supply pipes 444Y, 444M, 444C, and 444K.

The downstream end portions 444Yd and 444Md of the supply pipes 444Y and 444M are connected to upstream end portions, that is, left end portions, in the Y direction of the developing containers 3Y and 3M, respectively. The downstream end portions 444Cd and 444Kd of the supply pipes 444C and 444K are connected to downstream end portions, that is, right end portions, in the Y direction of the developing containers 3C and 3K, respectively. In this way, by distributing the supply pipes 444Y, 444M, 444C, and 444K to left and right sides of the developing containers 3Y, 3M, 3C, and 3K, lengths of the supply pipes 444Y, 444M, 444C, and 444K can be shortened.

For this reason, pressure loss in the supply pipes 444Y, 444M, 444C, and 444K can be reduced, and the image forming unit 500 can be made smaller.

Next, an arrangement of the toner cartridge 430Y will be described. As shown in FIG. 6B, the toner cartridge 430Y and the process cartridges PY, PM, PC, and PK are disposed to overlap a virtual line VL1 extending in the X direction. That is, as shown in FIGS. 1 and 6B, the toner cartridges 430Y, 430M, 430C, and 430K are disposed side by side with the process cartridges PY, PM, PC, and PK in the X direction. In other words, when viewed in the X direction, at least a part of each of the toner cartridges 430Y, 430M, 430C, and 430K is disposed to overlap the process cartridges PY, PM, PC, and PK in the Z direction. For this reason, the image forming unit 500 can be made smaller in the Z direction, that is, in the vertical direction, and the image forming apparatus 1 can be made smaller.

Also, in Example 1, the toner cartridges 430Y, 430M, 430C, and 430K are disposed as described above, but are not limited thereto. That is, the toner cartridges 430Y, 430M, 430C, and 430K may be disposed above the process cartridges PY, PM, PC, and PK in the Z direction.

Next, an arrangement of the supply pipes 444Y, 444M, 444C, and 444K will be described. As shown in FIGS. 4, 5B, and 7, the supply pipes 444Y, 444M, 444C, and 444K are disposed not to interfere with the above-described optical paths LY1, LM1, LC1, and LK1. Thus, the image forming unit 500 and the image forming apparatus 1 can be made smaller. In particular, the image forming unit 500 can be made smaller in the Y and Z directions.

The image forming unit 500 may be configured to allow easy access to the process cartridges PY, PM, PC, and PK and the supply pipes 444Y, 444M, 444C, and 444K. This is for the purpose of maintenance and replacement of the process cartridges PY, PM, PC, and PK and the supply pipes 444Y, 444M, 444C, and 444K. In Example 1, as shown in FIG. 8, the image forming unit 500 is configured to be able to be pulled out in the X direction relative to the apparatus main body 72 including the intermediate transfer belt unit 11. Thus, maintainability of the image forming unit 500 can be improved. Also, the image forming unit 500 may be configured so that it cannot be pulled out in the X direction relative to the apparatus main body 72.

### Schematic Configuration of Toner Cartridge

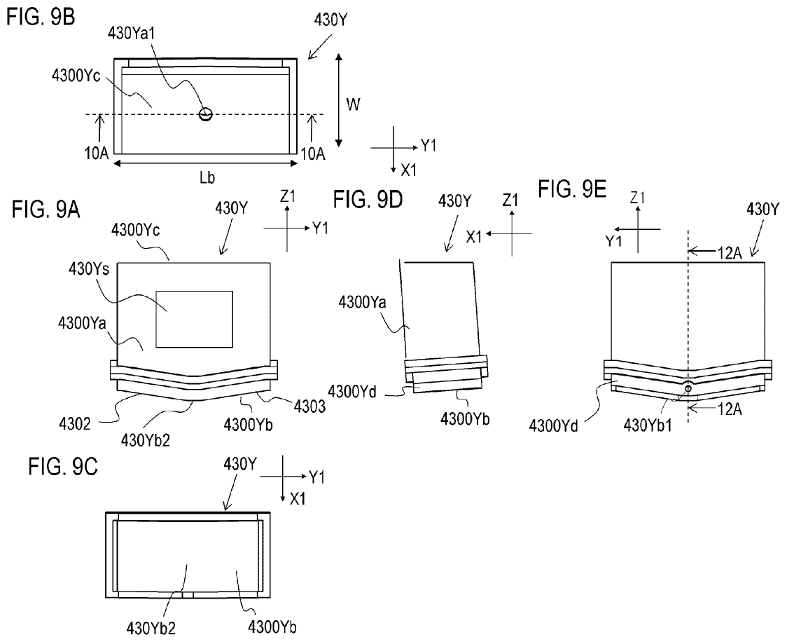

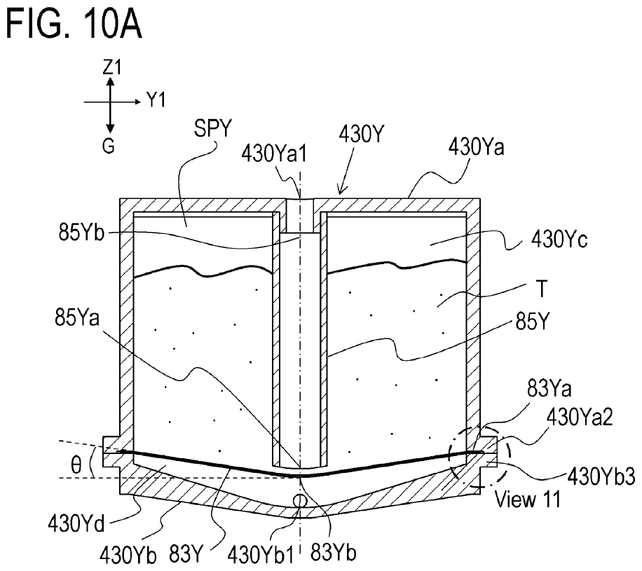

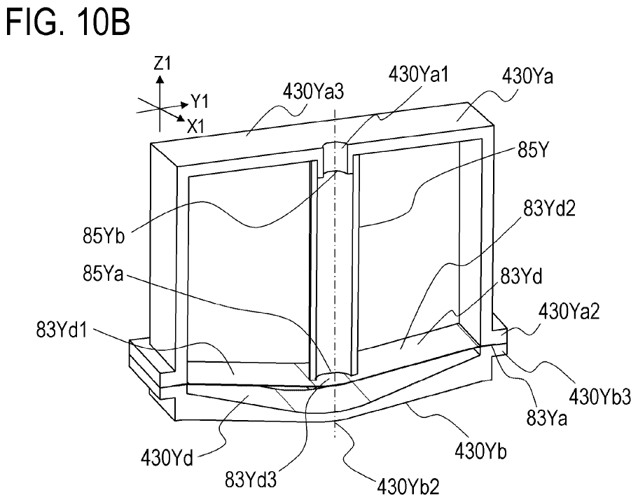

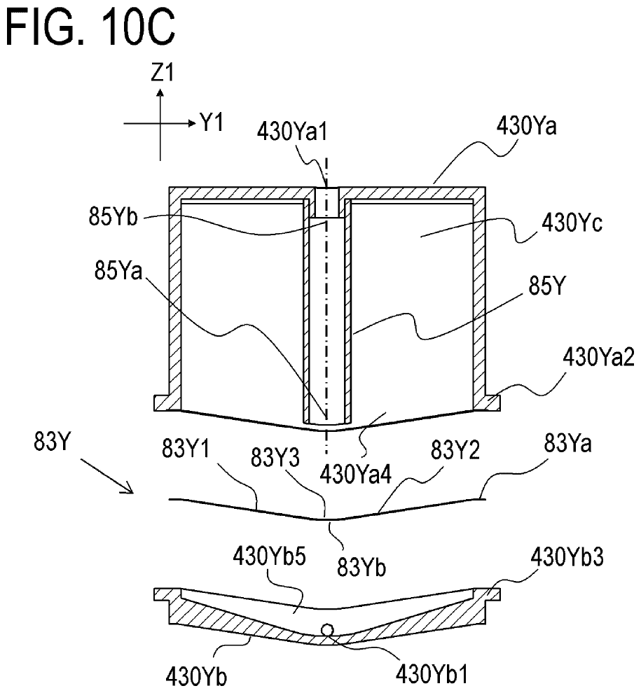

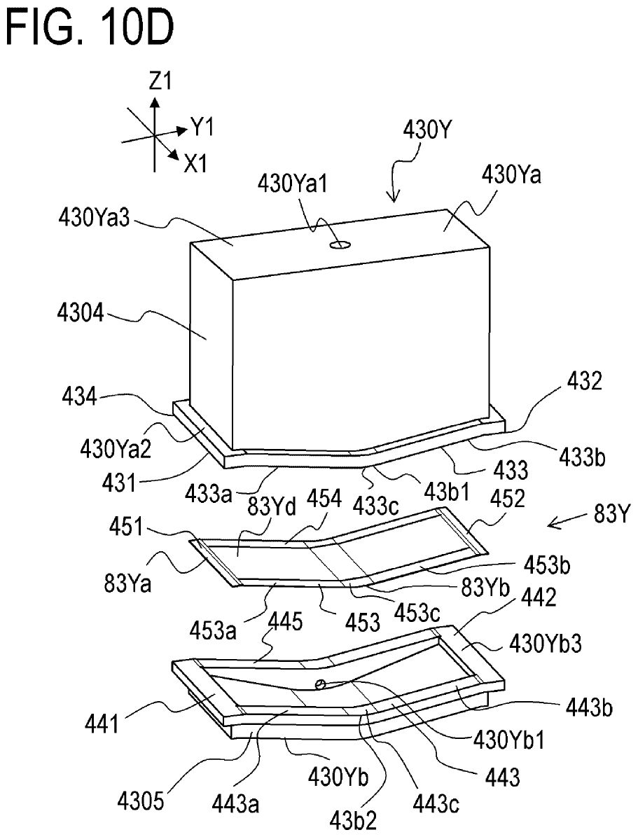

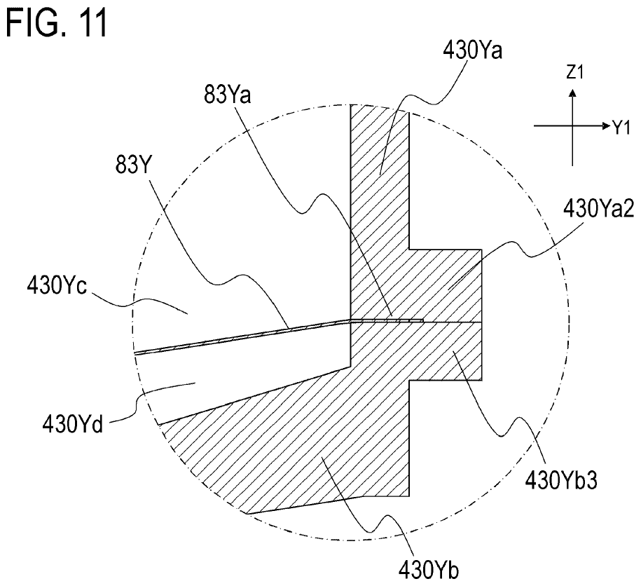

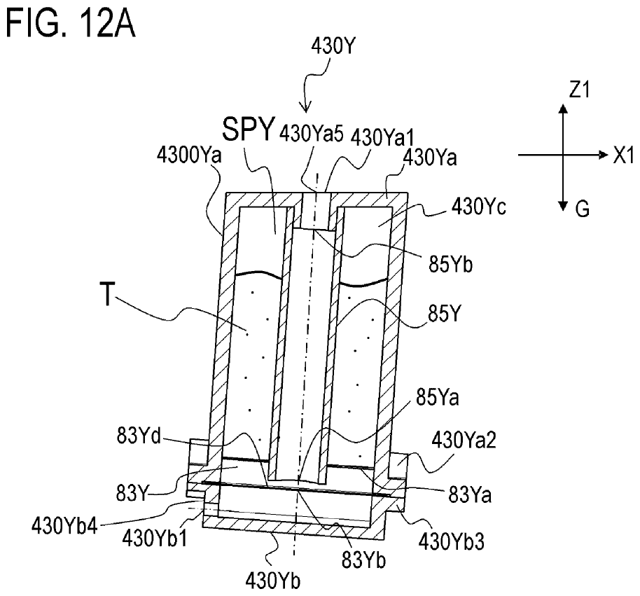

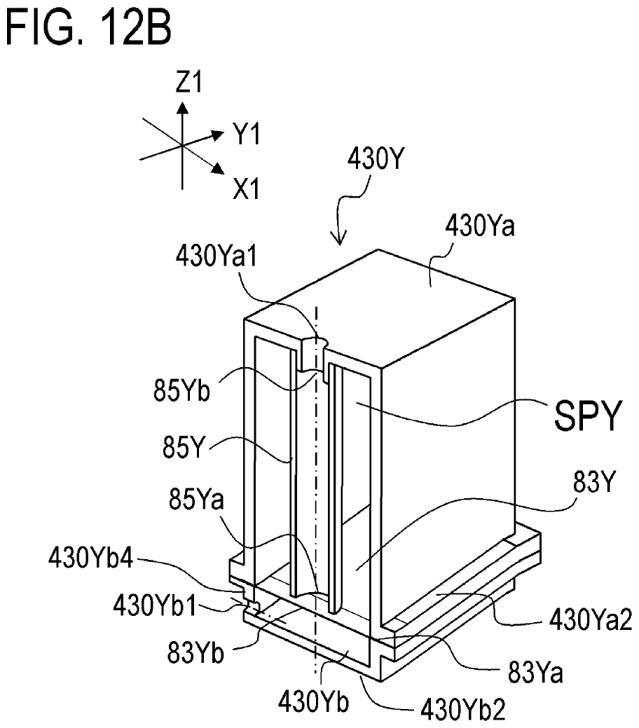

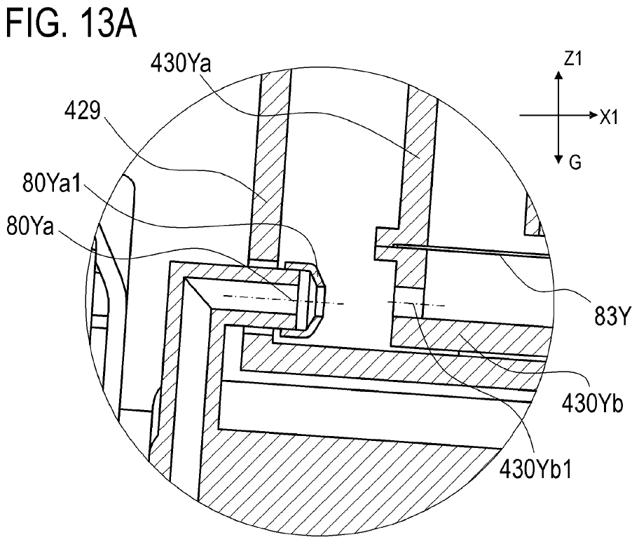

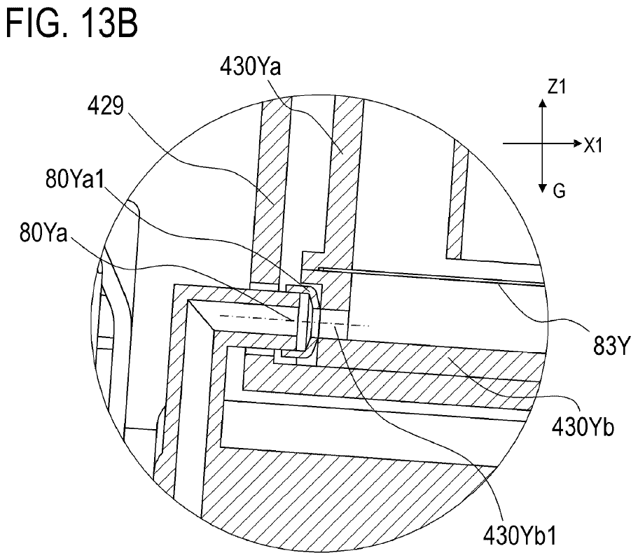

Next, a schematic configuration of the toner cartridge 430Y serving as the cartridge will be described with reference to FIGS. 9A to 9E to 13A and 13B. FIG. 9A is a front view showing the toner cartridge 430Y, and FIG. 9B is a top view showing the toner cartridge 430Y. FIG. 9C is a bottom view showing the toner cartridge 430Y, FIG. 9D is a side view showing the toner cartridge 430Y, and FIG. 9E is a rear view showing the toner cartridge 430Y. FIGS. 10A, 10B, and 10C show cross-sections along line 10A-10A in FIG. 9B, wherein FIG. 10A is a front view, FIG. 10B is a perspective view, and FIG. 10C is an exploded front view. FIG. 10D is an exploded perspective view showing the toner cartridge 430Y. FIG. 11 is a partial enlarged view showing a joint part between a first frame and a second frame shown in View 11 in FIG. 10A. FIGS. 12A and 12B show cross-sections along line 12A-12A in FIG. 9E, wherein FIG. 12A is a front view, and FIG. 12B is a perspective view. FIGS. 13A and 13B are partial enlarged views of View 13 in FIG. 6A, wherein FIG. 13A is a partial enlarged view of a state in which the toner cartridge is removed from the apparatus main body, and FIG. 13B is a partial enlarged view of a state in which the toner cartridge is attached to the apparatus main body.

As shown in FIG. 3A, the toner cartridge 430K has a width La in the Y direction, and the width La is wider than each width Lb of the toner cartridges 430Y, 430M, and 430C. Accordingly, a volume of the toner cartridge 430K for storing the toner is larger than a volume of each of the toner cartridges 430Y, 430M, and 430C. Generally, the black toner is consumed in greater quantities than other color toners, but as described above, the toner cartridge 430K can store more toner than the other toner cartridges 430Y, 430M, and 430C. For this reason, the number of times of replacement of the toner cartridges 430Y, 430M, 430C, and 430K can be equalized, and usability can be improved.

Also, in Example 1, lengths of the toner cartridges 430Y, 430M, 430C, and 430K in the X direction are the same length W. In addition, the length W in the X direction is shorter than the widths La and Lb in the Y direction.

The toner cartridges 430Y, 430M, 430C, and 430K have the same configuration except for the widths in the Y direction. In the following, only the toner cartridge 430Y will be described, and description of the toner cartridges 430M, 430C, and 430K will be omitted.

Also, in the following description, unless otherwise specified, directions (X1, Y1, and Z1) are defined as shown in FIGS. 9A to 9E to 12A and 12B on the basis of a posture of the toner cartridge 430Y described below. That is, a first direction (Z1 direction) is the direction of gravity, and the posture of the toner cartridge 430Y is oriented in a predetermined direction in which a toner storage chamber 430Yc is located above an air chamber 430Yd. The toner cartridge 430Y is configured to be removably attached to the apparatus main body 72 of the image forming apparatus 1 and is attached in the predetermined direction. In the posture of the toner cartridge 430Y oriented in this predetermined direction, the toner storage chamber 430Yc, a filter 83Y, and the air chamber 430Yd are arranged in order from above in the direction of gravity G (direction opposite to the Z1 direction, see FIG. 10A). In this posture, a lateral direction (X1 direction) and a longitudinal direction (Y1 direction) of the toner cartridge 430Y are parallel to the horizontal direction perpendicular to the direction of gravity G. In the posture, a direction opposite to the Z1 direction is the direction of gravity G, and the toner cartridge 430Y is oriented in a predetermined direction in which the toner storage chamber 430Yc is located above the air chamber 430Yd. In this case, the lateral direction of the toner cartridge 430Y is defined as the X1 direction, the longitudinal direction is defined as the Y1 direction, and the direction opposite to the direction of gravity is defined as the Z1 direction. That is, the direction of gravity G as the first direction is a direction in which a second frame 430Yb and the first frame 430Ya, which will be described later, are aligned. In addition, the Y1 direction as a third direction is a longitudinal direction of the first frame 430Ya that intersects the Z1 direction in a cross-section perpendicular to the Z1 direction. Further, the X1 direction as a second direction is a lateral direction of the first frame 430Ya that intersects both the Z1 direction and the Y1 direction.

A longitudinal direction of the toner cartridge 430Y is indicated by an X1 axis, and a direction from the back to the front is defined as the X1 direction. The X1 direction may be referred to as a forward direction or a direction toward the front. Also, a downstream side in the X1 direction of the toner cartridge 430Y may be referred to as a front side, and an upstream side thereof may be referred to as a back side.

A left to right direction of the toner cartridge 430Y is indicated by an Y1 axis, and a direction from the left to the right of the toner cartridge 430Y is defined as the Y1 direction. The Y1 direction may be referred to as a right direction. Also, a downstream side of the toner cartridge 430Y in the Y1 direction may be referred to as a right side, and an upstream side thereof may be referred to as a left side.

A vertical direction of the toner cartridge 430Y is indicated by a Z1 axis, and a direction from a lower side to an upper side of the toner cartridge 430Y is defined as the Z1 direction. The Z1 direction may be referred to as an upward direction, a height direction, or a vertical direction. A downstream side in the Z1 direction of the toner cartridge 430Y may be referred to as an upper side, an upper surface side, or a top surface side, and an upstream side thereof may be referred to as a lower side, a lower surface side, or a bottom surface side.

The X1 axis, the Y1 axis, and the Z1 axis are perpendicular to each other. For example, the X1 axis is perpendicular to the Y1 axis and also perpendicular to the Z1 axis. Also, a plane perpendicular to the X1 axis may be referred to as a Y1Z1 plane, a plane perpendicular to the Y1 axis may be referred to as a Z1X1 plane, and a plane perpendicular to the Z1 axis may be referred to as a X1Y1 plane.

As shown in FIGS. 9A to 9E and 10A to 10D, the toner cartridge 430Y has the first frame 430Ya as a first container, the second frame 430Yb as a second container, the filter 83Y, and a discharge pipe 85Y. In Example 1, the first frame 430Ya and the second frame 430Yb are made of resin materials, but may be made of paper or the like. As will be described in detail later, the filter 83Y is fixed in a sandwiched state between the first frame 430Ya and the second frame 430Yb.

In addition, an internal space SPY of the toner cartridge 430Y is divided by the filter 83Y into the toner storage chamber 430Yc and the air chamber 430Yd. That is, the toner storage chamber 430Yc is formed by the first frame 430Ya and the filter 83Y, and the air chamber 430Yd is configured by the second frame 430Yb and the filter 83Y. The air chamber 430Yd as a second chamber is disposed below the filter 83Y, and the toner storage chamber 430Yc is disposed above the filter 83Y.

The toner storage chamber 430Yc as a first chamber is configured to store toner T (see FIG. 12A), and the toner T is supported in the direction of gravity by the filter 83Y in the toner storage chamber 430Yc. The air chamber 430Yd does not store the toner T. The filter 83Y is configured of, for example, a porous member made of resin fibers. Holes of the filter 83Y are of a size and density that allow air to pass therethrough, but restrict passage of the toner T. That is, the filter 83Y is configured to allow air to pass therethrough and prevent the toner T from passing therethrough.

As shown in FIG. 9B, an upper surface 4300Yc of the first frame 430Ya is provided with a discharge port 430Ya1 through which the toner in the toner storage chamber 430Yc is discharged to the outside of the toner cartridge 430Y. The discharge port 430Ya1 is configured of a through hole penetrating the first frame 430Ya in the Z1 direction.

As shown in FIG. 9E, a back surface 4300Yd of the second frame 430Yb is provided with an intake port 430Yb1 as a container opening configured of a through hole penetrating in the X1 direction. The discharge port 430Ya1 and the intake port 430Yb1 communicate with the outside of the toner cartridge 430Y.

These discharge port 430Ya1 and intake port 430Yb1 may be provided on sides other than both left and right sides among all sides constituting the toner cartridge 430Y. In other words, the discharge port 430Ya1 and the intake port 430Yb1 may be provided on sides of the toner cartridge 430Y except for sides aligned in the Y1 direction, which is a direction in which the toner cartridges 430Y, 430M, 430C, and 430K are aligned. Thus, as shown in FIG. 3A, gaps Gym, Gmc, and Gck in the Y direction (Y1 direction) between the respective toner cartridges 430Y, 430M, 430C, and 430K can be narrowed. As a result, the widths of the toner cartridges 430Y, 430M, 430C, and 430K in the Y direction can be increased, and the toner capacity that can be stored in the toner cartridges 430Y, 430M, 430C, and 430K can be increased.

Also, the gap Gym is a gap in the Y direction between the toner cartridge 430Y and the toner cartridge 430M. The gap Gmc is a gap in the Y direction between the toner cartridge 430M and the toner cartridge 430C. The gap Gck is a gap in the Y direction between the toner cartridge 430C and the toner cartridge 430K.

Also, as shown in FIG. 9A, a bottom surface 4300Yb of the second frame 430Yb is inclined downward (upstream in the Z direction) toward a center in the Y1 direction. That is, the bottom surface 4300Yb has a first inclined surface 4302 inclined downward toward the downstream side in the Y1 direction, and a second inclined surface 4303 inclined downward toward the upstream side in the Y1 direction. In addition, a boundary portion between the first inclined surface 4302 and the second inclined surface 4303 is the lowest surface portion 430Yb2 of the bottom surface 4300Yb.

As shown in FIG. 3B, the cartridge holder 429 is provided with the intake port 429Ya that engages with the discharge port 430Ya1 of the toner cartridge 430Y. Also, the discharge port 80Ya engaged with the intake port 430Yb1 of the toner cartridge 430Y is provided. In addition, dividing portions 429ym, 429mc, and 429ck that divide the respective cartridges are provided. The discharge port 80Ya opens upstream in the X1 direction. That is, the discharge port 80Ya opens in the same direction as the direction in which the toner cartridge 430Y is attached to the cartridge holder 429. For this reason, when the toner cartridge 430Y is attached to the cartridge holder 429, the discharge port 430Ya1 is easily engaged to communicate with the discharge port 80Ya of the cartridge holder 429.

The toner cartridge 430Y and the discharge port 80Ya of the cartridge holder 429 can be connected to each other without air leakage by a configuration having a seal member as shown in FIGS. 13A and 13B. As shown in FIG. 13A, a discharge port seal 80Ya1 including a cylindrical holding portion and a conical engaging portion with a hole at its tip is attached to an end portion of the discharge port 80Ya. The discharge port seal 80Ya1 is made of a flexible material such as an elastomer. When the toner cartridge 430Y is attached to the cartridge holder 429, its state changes from FIG. 13A to FIG. 13B. In this case, the conical portion of the discharge port seal 80Ya1 is pressed toward a position at which it faces the intake port 430Yb1 of the toner cartridge 430Y while being deformed in an attaching direction, that is, upstream in the X1 direction. As described above, the discharge port seal 80Ya1 is made of a flexible material such as an elastomer and has a high friction coefficient, and a high sealing effect can be expected even with a small amount of deformation, and thus the user can attach and detach the toner cartridge with a light operating force. Also, in Example 1, a configuration in which the discharge port seal member is provided on the cartridge holder side has been described, but the seal member may be provided on the toner cartridge side. In that case, the cartridge holder side is provided with a simple opening and the toner cartridge side is provided with a seal member made of a flexible material such as an elastomer.

Also, the toner cartridge 430Y may be provided with a sealing member (not shown) that seals the discharge port 430Ya1 that is a toner discharge portion. The sealing member is configured of a seal, a shutter, or the like. In a state in which the toner cartridge 430Y is not attached to the cartridge holder 429, the sealing member seals the discharge port 430Ya1, thereby inhibiting leakage of the toner in the toner storage chamber 430Yc to the outside of the toner cartridge 430Y. In a case in which the sealing member is configured of a seal, when the toner cartridge 430Y is attached to the cartridge holder 429, the sealing member is removed from an upper surface 4300Yc of the toner cartridge 430Y. In a case in which the sealing member is configured of a shutter, when the toner cartridge 430Y is attached to the cartridge holder 429, the sealing member is moved relative to the upper surface 4300Yc of the toner cartridge 430Y to open the discharge port 430Ya1.

Also, as shown in FIG. 9A, a label 430Ys is provided on a front surface 4300Ya of the toner cartridge 430Y. The label 430Ys is for indicating the color of the toner stored in the toner cartridge 430Y. The label 430Ys is omitted in the figures other than FIG. 9A. The label 430Ys may display a method of attaching the toner cartridge 430Y to the cartridge holder 429 or information about the toner cartridge 430Y. For example, the label 430Ys may include information such as a toner volume that can be stored in the toner cartridge 430Y, an expiration date of the toner, a method of storing the toner cartridge 430Y, and how to remove the above-described sealing member.

### Toner Transport Mechanism

Next, a mechanism will be described in which the toner stored in the toner storage chamber 430Yc of the toner cartridge 430Y is conveyed to the developing container 3Y of the process cartridge PY. As shown in FIG. 6A, the air discharged from the discharge port 80Ya of the pump unit 80Y is taken into the air chamber 430Yd via the intake port 430Yb1 (see FIG. 10A) of the toner cartridge 430Y. Then, the air fills the air chamber 430Yd, passes through the filter 83Y, and flows into the toner storage chamber 430Yc.

The air flowing into the toner storage chamber 430Yc enters between particles of the toner T to fluidize the toner T. The inside of the toner cartridge 430Y becomes a positive pressure due to inflow of the air from the pump unit 80Y, and the air passes through the discharge pipe 85Y and attempts to exit the toner cartridge 430Y from the discharge port 430Ya1. In this case, the toner T in the toner storage chamber 430Yc is moved through the discharge pipe 85Y together with the air and is discharged from the discharge port 430Ya1 to the outside of the toner cartridge 430Y. That is, the discharge pipe 85Y guides the toner in the toner storage chamber 430Yc together with the air from an inlet 85Ya to the discharge port 430Ya1.

The toner T discharged from the discharge port 430Ya1 enters the upstream end portion 444Yu of the supply pipe 444Y via the intake port 429Ya of the cartridge holder 429. Then, the toner T is conveyed inside the supply pipe 444Y by the air flowing into the supply pipe 444Y together with the toner T, and supplied to the developing container 3Y of the process cartridge PY from the downstream end portion 444Yd of the supply pipe 444Y. As shown in FIG. 5B, since the downstream end portion 444Yd of the supply pipe 444Y is connected to the upstream end portion of the developing container 3Y in the Y direction (Y1 direction), the toner T is supplied to the upstream end portion of the developing container 3Y in the Y direction.

Here, as shown in FIG. 6B, in the developing container 3Y, stirring members SY1 and SY2 that stir the toner in the developing container 3Y are rotatably provided. Similarly, inside the developing containers 3M, 3C, and 3K, stirring members SM1 and SM2, stirring members SC1 and SC2, and stirring members SK1 and SK2 are respectively provided.

The toner in the developing container 3Y is leveled by rotation of the stirring members SY1 and SY2 and conveyed in the Y direction (Y1 direction). Also, in Example 1, these stirring members are each configured of a rotating shaft and a sheet member fixed to the rotating shaft, but are not limited thereto. For example, the stirring members may be configured of screws configured to convey the toner in the developing container in the Y direction. That is, the stirring members SY1, SY2, SM1, and SM2 are configured of screws for conveying the toner downstream in the Y direction, and the stirring members SC1, SC2, SK1, and SK2 are configured of screws for conveying the toner upstream in the Y direction.

Since not only the toner T but also the air flows into the developing container 3Y, an internal pressure of the developing container 3Y increases. For this reason, in Example 1, as shown in FIGS. 3A and 5B, a through hole (not shown) is provided on an upper surface of the developing container 3Y, and the through hole is covered with an exhaust filter PYf. The exhaust filter PYf is made of a non-woven fabric or the like and is configured to allow the air to pass therethrough and restrict the toner from passing therethrough. Thus, the toner flowing into the developing container 3Y is regulated from being discharged to the outside by the exhaust filter PYf, and remains in the developing container 3Y. On the other hand, at least some of the air flowing into the developing container 3Y is discharged to the outside of the developing container 3Y through the exhaust filter PYf. Thus, an increase in the internal pressure of the developing container 3Y is inhibited, and supply of the toner to the developing container 3Y can smoothly performed.

Similarly, exhaust filters PMf, PCf, and PKf and through holes (not shown) covered by these exhaust filters PMf, PCf, and PKf are provided on upper surfaces of the developing containers 3M, 3C, and 3K.

The exhaust filter PYf and the through hole are provided at a center portion of the developing container 3Y in the Y direction. The number of exhaust filter and through hole are not limited to one, and a plurality of exhaust filters and through holes may be provided in the developing container 3Y. For example, as shown in FIGS. 3A and 5B, in addition to the exhaust filter PYf, exhaust filters PYfa and PYfb may be provided in the developing container 3Y. The exhaust filters PYfa and PYfb cover through holes (not shown) provided in the developing container 3Y. The exhaust filter PYfa is disposed upstream from the exhaust filter PYf in the Y direction, the exhaust filter PYfb is disposed downstream from the exhaust filter PYf in the Y direction. In this way, by providing the plurality of exhaust filters and through holes for one developing container, an increase in the internal pressure of the developing container can be efficiently inhibited.

As described above, the toner stored in the toner cartridge 430Y is conveyed to the developing container 3Y together with the air and supplied to the developing container 3Y. As in the supply pipes 444Y, 444M, 444C, and 444K of Example 1, in the case of a configuration in which a direction of a conveying passage is changed halfway, or a configuration in which the conveying passage is different depending on the color of the toner, the toner may be conveyed using air. By conveying the toner using air, a degree of freedom in designing a toner conveying passage is improved, and members such as screws for conveying the toner are not required, and thus the number of components can be reduced, and costs can be reduced.

### Detailed Configuration of Toner Cartridge Frame

Next, a detailed configuration of the toner cartridge 430Y will be described with reference to FIGS. 10A to 10D to 12A and 12B. As shown in FIGS. 10A to 10D to 12A and 12B, the first frame 430Ya has a first box portion 4304 that forms the toner storage chamber 430Yc together with a bottom surface portion 83Yd of the filter 83Y. In addition, the first frame 430Ya has a first flange portion 430Ya2 that extends in a substantially horizontal direction from a lower end portion of the first box portion 4304 toward the outside of the toner storage chamber 430Yc. The first box portion 4304 is formed in a substantially rectangular parallelepiped shape. The first flange portion 430Ya2 is formed over the entire periphery of the lower end portion of the first box portion 4304.

The second frame 430Yb is formed separately from the first frame 430Ya. The second frame 430Yb has a second box portion 4305 that forms the air chamber 430Yd together with the bottom surface portion 83Yd of the filter 83Y. In addition, the second frame 430Yb has a second flange portion 430Yb3 that extends in a substantially horizontal direction from an upper end portion of the second box portion 4305 toward the outside of the air chamber 430Yd. The second flange portion 430Yb3 is formed over the entire periphery of the upper end portion of the second box portion 4305.

### Filter

The filter 83Y is formed in a rectangular and sheet shape. Also, the filter 83Y has the bottom surface portion 83Yd serving as a dividing portion that divides the air chamber 430Yd and the toner storage chamber 430Yc. In addition, the filter 83Y has an outer edge portion 83Ya serving as a nipped portion that is sandwiched and held by the first flange portion 430Ya2 and the second flange portion 430Yb3. The outer edge portion 83Ya is provided to be continuous with the bottom surface portion 83Yd. The bottom surface portion 83Yd is formed to come closer to the lowest portion 83Yb of the filter 83Y in the longitudinal direction (Y1 direction) as going downward in the direction of gravity G, and forms a bottom surface of the toner storage chamber 430Yc. In other words, when viewed in the X1 direction, the bottom surface portion 83Yd is inclined downward toward the lowest portion 83Yb of the filter 83Y in the direction of gravity G as coming closer to the lowest portion 83Yb in the Y1 direction. As shown in FIG. 10B, the bottom surface portion 83Yd has a first inclined surface 83Yd1 that is inclined downward as coming closer to the lowest portion 83Yb from one end (upstream end) of the bottom surface portion 83Yd in the Y1 direction. Further, the bottom surface portion 83Yd has a second inclined surface 83Yd2 that is inclined downward as coming closer to the lowest portion 83Yb from the other end (downstream end) of the bottom surface portion 83Yd in the Y1 direction.

In other words, in a case in which both end portions of the toner cartridge 430Y in the Y1 direction are defined as a first end portion and a second end portion when viewed in the X1 direction, the lowest portion 83Yb of the filter 83Y is disposed between the first end portion and the second end portion in the Y1 direction. Also, the first inclined surface 83Yd1 as a first portion is configured to be inclined downward in the Y1 direction from the first end portion toward the lowest portion 83Yb. The second inclined surface 83Yd2 as a second portion is configured to be inclined downward in the Y1 direction from the second end portion toward the lowest portion 83Yb. In other words, as shown in FIG. 10C, when viewed in the X1 direction, the filter 83Y has, in the Y1 direction, a first end portion 83Y1, a second end portion 83Y2 on a side opposite to the first end portion 83Y1, and an intermediate portion 83Y3 between the first end portion 83Y1 and the second end portion 83Y2. The intermediate portion 83Y3 has the lowest portion 83Yb.

Also, the bottom surface portion 83Yd is provided between the first inclined surface 83Yd1 and the second inclined surface 83Yd2 in the Y1 direction, and has the intermediate surface 83Yd3 in which the lowest portion 83Yb is located. The intermediate surface 83Yd3 is configured to be curved to smoothly connect the first inclined surface 83Yd1 to the second inclined surface 83Yd2. Also, the intermediate surface 83Yd3 may be omitted, and the first inclined surface 83Yd1 and the second inclined surface 83Yd2 may be directly connected to each other.

### Joint Surface

As shown in FIG. 10D, the first flange portion 430Ya2 of the first frame 430Ya has a first joint surface 431, a second joint surface 432, a third joint surface 433, and a fourth joint surface 434. The second flange portion 430Yb3 of the second frame 430Yb has a first joint surface 441, a second joint surface 442, a third joint surface 443, and a fourth joint surface 445. The first joint surface 431 and the second joint surface 432 of the first flange portion 430Ya2 extend in the X1 direction and are formed in plat surface shapes. The first joint surface 431 and the second joint surface 432 are formed to be continuous with the third joint surface 433 and the fourth joint surface 434. The first joint surface 431 is provided on a left end side of the first flange portion 430Ya2, and the second joint surface 432 is provided on a right end side of the first flange portion 430Ya2. The third joint surface 433 is provided on a front end side of the first flange portion 430Ya2, and the fourth joint surface 434 is provided on a rear end side of the first flange portion 430Ya2. Since these third and fourth joint surfaces 433 and 434 are configured in the same manner, the third joint surface 433 will be described mainly.

The third joint surface 433 has a first inclined surface 433a as an inclined surface that is inclined downward as going downstream in the Y1 direction, a second inclined surface 433b that is inclined downward as going upstream in the Y1 direction, and an intermediate surface 433c. When viewed in the X1 direction, the first inclined surface 433a is inclined downward toward the lowest portion 43b1 in the direction of gravity G as coming closer to the lowest portion 43b1 corresponding to the lowest portion 83Yb of the filter 83Y in the Y1 direction. When viewed in the X1 direction, the second inclined surface 433b is disposed on a side opposite to the first inclined surface 433a from the lowest portion 43b1 in the Y1 direction, and is inclined downward toward the lowest portion 43b1 in the direction of gravity G as coming closer to the lowest portion 43b1. When viewed in the X1 direction, the intermediate surface 433c is provided between the first inclined surface 433a and the second inclined surface 433b in the Y1 direction, and is configured to be curved to smoothly connect the first inclined surface 433a to the second inclined surface 433b.

Also, the intermediate surface 433c may be omitted, and the first inclined surface 433a and the second inclined surface 433b may be directly connected to each other, and the intermediate surface 433c may be configured as a flat surface. In addition, not limited to the entire first inclined surface 433a, a part of the first inclined surface 433a may form an inclined surface or a nipping surface.

The first joint surface 441 and the second joint surface 442 of the second flange portion 430Yb3 extend in the X1 direction and are formed in plat surface shapes. The first joint surface 441 is provided on a left end side of the second flange portion 430Yb3, and the second joint surface 442 is provided on a right end side of the second flange portion 430Yb3. The third joint surface 443 is provided on a front end side of the second flange portion 430Yb3, and the fourth joint surface 445 is provided on a rear end side of the second flange portion 430Yb3. Since these third and fourth joint surfaces 443 and 445 are configured in the same manner, the third joint surface 443 will be described mainly.

The third joint surface 443 has a first inclined surface 443a as a first nipping surface that is inclined downward as going downstream in the Y1 direction. Also, the third joint surface 443 has a second inclined surface 443b as a second nipping surface that is inclined downward as going upstream in the Y1 direction. In addition, the third joint surface 443 has an intermediate surface 443c as an intermediate nipping surface. The first inclined surface 443a, the second inclined surface 443b, and the intermediate surface 443c respectively face the first inclined surface 433a, the second inclined surface 433b, and the intermediate surface 433c in the direction of gravity G. In other words, the first inclined surface 443a, the second inclined surface 443b, and the intermediate surface 443c are disposed at positions at which they respectively overlap the first inclined surface 433a, the second inclined surface 433b, and the intermediate surface 433c in the direction of gravity G. When viewed in the X1 direction, the intermediate surface 443c is provided between the first inclined surface 443a and the second inclined surface 443b in the Y1 direction, and is configured to be curved to smoothly connect the first inclined surface 443a to the second inclined surface 443b.

When viewed in the X1 direction, the first inclined surface 443a and the second inclined surface 443b are inclined downward along the first inclined surface 433a and the second inclined surface 433b as they come closer to the lowest portion 43b2 corresponding to the lowest portion 83Yb of the filter 83Y in the Y1 direction. Also, the intermediate surface 443c may be omitted, the first inclined surface 443a and the second inclined surface 443b may be directly connected to each other, and the intermediate surface 443c may be configured of a flat surface. In addition, not limited to the entire first inclined surface 443a, a part of the first inclined surface 443a may form a nipping surface or an inclined surface.

The outer edge portion 83Ya of the filter 83Y has a first edge portion 451, a second edge portion 452, a third edge portion 453, and a fourth edge portion 454. The first edge portion 451 and the second edge portion 452 of the outer edge portion 83Ya of the filter 83Y are formed in plat surface shapes extending in the X1 direction. The first edge portion 451 is provided on a left end side of the outer edge portion 83Ya, and the second edge portion 452 is provided on a right end side of the outer edge portion 83Ya. The third edge portion 453 is provided on a front end side of the outer edge portion 83Ya, and the fourth edge portion 454 is provided on a rear end side of the outer edge portion 83Ya. Since these third edge portion 453 and fourth edge portion 454 are configured in the same manner, the third edge portion 453 will be mainly described.

The third edge portion 453 has a first inclined surface 453a as a nipped surface and a first nipped surface that is inclined downward as going downstream in the Y1 direction. Also, the third edge portion 453 has a second inclined surface 453b as a second nipped surface that is inclined downward as going upstream in the Y1 direction. In addition, the third edge portion 453 has an intermediate surface 453c as an intermediate nipped surface. The first inclined surface 453a of the third edge portion 453 of the filter 83Y faces the first inclined surface 433a of the first flange portion 430Ya2 and the first inclined surface 443a of the second flange portion 430Yb3 in the direction of gravity G. The second inclined surface 453b of the third edge portion 453 of the filter 83Y faces the second inclined surface 433b of the first flange portion 430Ya2 and the second inclined surface 443b of the second flange portion 430Yb3 in the direction of gravity G. The intermediate surface 453c of the third edge portion 453 of the filter 83Y faces the intermediate surface 433c of the first flange portion 430Ya2 and the intermediate surface 443c of the second flange portion 430Yb3 in the direction of gravity G.

In addition, the first flange portion 430Ya2 and the second flange portion 430Yb3 are joined by ultrasonically welding the first joint surfaces 431 and 441, the second joint surfaces 432 and 442, the third joint surfaces 433 and 443, and the fourth joint surfaces 434 and 445 to each other. In this case, the third joint surfaces 433 and 443 and the fourth joint surfaces 434 and 445 are disposed to overlap the bottom surface portion 83Yd of the filter 83Y when viewed in the lateral direction (X1 direction). Also, the first flange portion 430Ya2 and the second flange portion 430Yb3 may be fixed to each other not only by ultrasonic welding, but also by heat welding, adhesives such as a double-sided tape or hot melt, screws, or the like.

These first flange portion 430Ya2 and second flange portion 430Yb3 are joined together, and thus the filter 83Y sandwiched between the first flange portion 430Ya2 and the second flange portion 430Yb3 is held. Also, when a holding force of the filter 83Y is insufficient, the entire periphery of the outer edge portion 83Ya of the filter 83Y may be bonded to at least one of the first flange portion 430Ya2 and the second flange portion 430Yb3. Thus, the filter 83Y can be held with high holding force.

Further, since the filter 83Y is sandwiched between the first flange portion 430Ya2 and the second flange portion 430Yb3, it is held in a posture along the respective joint surfaces of the first flange portion 430Ya2 and the second flange portion 430Yb3. In particular, the third edge portion 453 of the filter 83Y is sandwiched between third joint surfaces 433 and 443 formed in a substantially V-shape, and the fourth edge portion 454 of the filter 83Y is sandwiched between fourth joint surfaces 434 and 445 formed in a substantially V-shape. For this reason, the filter 83Y is held in a substantially V-shaped posture in which the lowest portion 83Yb is a lower end portion thereof.

In addition, the lowest portion 83Yb of the filter 83Y extends in the lateral direction (X1 direction), and the bottom surface portion 83Yd of the filter 83Y extends parallel to the lateral direction (X1 direction) over the entire region in the lateral direction (X1 direction). In other words, the bottom surface portion 83Yd has the same distance in the direction of gravity G or Z1 direction with respect to an outlet 85Yb over the entire region in the lateral direction (X1 direction) in a predetermined cross-section perpendicular to the longitudinal direction (Y1 direction). That is, as shown in FIG. 12A, in the X1Z1 plane, a distance GD in the Z1 direction between a center 430Ya5 of the discharge port 430Ya1 and the bottom surface portion 83Yd is equal over the entire region in the lateral direction (X1 direction). Also, the first joint surface 441 faces the first joint surface 431 in the direction of gravity G. In other words, the first joint surface 441 is disposed at a position at which it overlaps the first joint surface 431 in the direction of gravity G.

That is, the filter 83Y has a shape in which one rectangular sheet is folded into a valley fold shape at the lowest portion 83Yb, and does not have a complex three-dimensional uneven shape. For this reason, the filter 83Y can be formed, for example, from a sheet-like non-woven fabric made of resin fibers, and does not need to be molded three-dimensionally by heat pressing or the like. In other words, the filter 83Y is a flat sheet when the outer edge portion 83Ya is not sandwiched between the first frame 430Ya and the second frame 430Yb. Thus, the filter 83Y can be inexpensively configured and held in a generally V-shaped posture. As compared to a molded member formed by heat pressing or the like, the sheet-like filter 83Y can be made thinner, and the toner capacity of the toner cartridge 430Y can be increased.

Also, in order to move the toner along the inclined surface only by its own weight, it is usually required to set an inclination angle θ of the inclined surface relative to the horizontal plane to about 70 degrees. However, in Example 1, the toner on the filter 83Y in the toner storage chamber 430Yc is fluidized by air, and thus, as shown in FIG. 10A, the inclination angle of the inclined surface of the filter 83Y with respect to the horizontal plane may be about 10 to 20 degrees. Thus, the volume of the toner cartridge 430Y can be increased, and the amount of toner that can be stored in the toner cartridge 430Y can be increased.

Also, in Example 1, both the first frame 430Ya and the second frame 430Yb are provided with the third joint surfaces 433 and 443 that abut the third edge portion 453 of the outer edge portion 83Ya of the filter 83Y and are inclined with respect to the longitudinal direction (Y1 direction) and the direction of gravity G. However, the present disclosure is not limited thereto. That is, at least one of the first frame 430Ya and the second frame 430Yb may be provided with the third joint surface 433. In addition, at least the other of the first frame 430Ya and the second frame 430Yb may be provided with a nipping surface that nips the third edge portion 453 together with the third joint surface 433. For example, among the first frame 430Ya and the second frame 430Yb, only the first frame 430Ya may be provided with the third joint surface 433 that abuts the third edge portion 453 and is inclined with respect to the longitudinal direction (Y1 direction) and the direction of gravity G. In this case, the third joint surface 443 as the nipping surface of the second frame 430Yb may be formed parallel to the Y1Z1 plane, and a seal member (not shown) may be provided between the third joint surface 433 and the third joint surface 443.

### Discharge Pipe

As shown in FIGS. 10A to 10C, a discharge pipe 85Y is disposed inside the toner storage chamber 430Yc. The discharge pipe 85Y has the inlet 85Ya that opens downward in the direction of gravity G. Also, the discharge pipe 85Y opens upward, that is, downstream in the Z1 direction, communicates with the discharge port 430Ya1 of the toner cartridge 430Y, and has the outlet 85Yb as a second pipe opening that communicates with the outside of the toner cartridge 430Y. The outlet 85Yb is located linearly above the inlet 85Ya. Since the discharge pipe 85Y has no bent portion or the like in the middle, pressure loss during convey can be inhibited to the minimum.

Also, as shown in FIGS. 12A and 12B, the inlet 85Ya is disposed near a center portion of the container in the X1 direction. The filter 83Y does not have a gradient in the X1 direction, and is less effective at conveying the toner. By disposing it near the center portion, distances from both end portions in the X1 direction to the inlet 85Ya become equal, and as compared to a configuration in which the inlet 85Ya is located at one end and its distance to the other end is larger, the amount of toner remaining without being supplied in the toner storage chamber 430Yc can be reduced. In Example 1, the discharge pipe 85Y is made of a resin material, but may be made of paper, rubber, or the like. Further, in Example 1, the discharge pipe 85Y is configured as a separate member from the first frame 430Ya, but since the discharge pipe 85Y does not have a bent portion or the like in the middle as described above, it can be formed integrally with the first frame 430Ya.

As shown in FIG. 12B, the inlet 85Ya is disposed with a gap from the lowest portion 83Yb of the intermediate portion 83Y3 serving as an opposing region of the filter 83Y. This gap serves as an inflow port for the toner.

As described above, the filter 83Y is held in a substantially V-shaped posture with the lowest portion 83Yb as the lower end portion. When the amount of toner remaining in the toner storage chamber 430Yc becomes low, the toner fluidized by the air moves along the inclination of the filter 83Y and collects to the lowest portion 83Yb. That is, the toner in the toner storage chamber 430Yc can be guided toward the inlet 85Ya of the discharge pipe 85Y. Also, the bottom surface portion 83Yd of the filter 83Y extends parallel to the lateral direction (X1 direction) and is inclined only in the longitudinal direction (Y1 direction). For this reason, the filter 83Y is simply configured, and the toner can be efficiently collected to the lowest portion 83Yb of the filter 83Y. For this reason, even when the amount of toner remaining in the toner storage chamber 430Yc is reduced, the toner collected in the lowest portion 83Yb can be efficiently discharged from the inlet 85Ya of the discharge pipe 85Y to the outside of the toner cartridge 430Y via the discharge port 430Ya1.

The toner cartridge 430Y of Example 1 has the toner storage chamber 430Yc, which is the first chamber for storing the toner, and the air chamber 430Yd, which is the second chamber provided to be aligned with the toner storage chamber 430Yc in the Z direction, which is the first direction. The toner cartridge 430Y has the filter 83Y provided to divide the toner storage chamber 430Yc and the air chamber 430Yd, allowing the air to pass therethrough and restricting the passage of the toner. The toner cartridge 430Y has the discharge port 430Ya1 for discharging the toner stored in the toner storage chamber 430Yc to the outside of the toner cartridge 430Y. Also, the toner cartridge 430Y has the intake port 430Yb1 for taking the air into the air chamber 430Yd from the outside of the toner cartridge 430Y. The toner cartridge 430Y has the discharge pipe 85Y that is a discharge pipe portion for communicating the discharge port 430Ya1 with the inside of the toner storage chamber 430Yc. The discharge port 430Ya1 is provided on a first end surface of the toner cartridge 430Y in the first direction (Z1 direction). When the first direction (Z1 direction) is the direction of gravity and the toner cartridge 430Y is oriented in a predetermined direction in which the toner storage chamber 430Yc is located above the air chamber 430Yd, the first end surface of the toner cartridge 430Y is an upper surface 430Ya3 thereof. That is, the discharge port 430Ya1 is provided on the upper surface 430Ya3 when the toner cartridge 430Y is oriented in the predetermined direction (see FIGS. 10B and 10D). The intake port 430Yb1 is provided on a second end surface 430Yb4, which is an end surface of the toner cartridge 430Y in the X1 direction, which is the second direction intersecting the Z1 direction (see FIGS. 12A and 12B).

The toner cartridge 430Y is configured to be removably attached to the apparatus main body 72 of the image forming apparatus 1, and is attached in the predetermined direction. The discharge pipe 85Y is provided inside the toner storage chamber 430Yc. The outlet 85Yb, which is the downstream end portion in a toner discharge direction of the discharge pipe 85Y, is connected to the discharge port 430Ya1, and the inlet 85Ya, which is the upstream end portion in the discharge direction, faces the filter 83Y and opens toward the filter 83Y.

The discharge pipe 85Y extends linearly from the filter 83Y toward the discharge port 430Ya1. The toner cartridge 430Y is configured to be removably attached to the apparatus main body 72 of the image forming apparatus 1. The second end surface 430Yb4 of the toner cartridge 430Y is a downstream end surface in the attaching direction of the toner cartridge 430Y to the apparatus main body 72.

In a case in which the toner cartridge 430Y is oriented in a predetermined direction, when viewed in the second direction (X1 direction), the filter 83Y has the first end portion 83Y1, the second end portion 83Y2, and the intermediate portion 83Y3 in the third direction (Y1 direction). The second end portion 83Y2 is located on a side opposite to the first end portion in the Y1 direction, and the intermediate portion 83Y3 is located between the first end portion 83Y1 and the second end portion 83Y2 in the Y1 direction. The intermediate portion 83Y3 has the lowest portion 83Yb (see FIG. 10C). The filter 83Y is provided with the first inclined surface 453a and the first inclined surface 83Yd1 forming a first inclined region inclined downward as coming closer to the intermediate portion 83Y3 from the first end portion 83Y1. Further, the filter 83Y is provided with the second inclined surface 453b and the second inclined surface 83Yd2 forming a second inclined region inclined downward as coming closer to the intermediate portion 83Y3 from the second end portion 83Y2 (see FIGS. 10B and 10D). The inlet 85Ya, which is the upstream end portion of the discharge pipe 85Y, opens to face the intermediate portion 83Y3 of the filter 83Y (see FIG. 10C).

The discharge port 430Ya1 is provided at a position including the center on the upper surface 430Ya3 of the toner cartridge 430Y in the second direction (X1 direction) (see FIGS. 12A and 12B). Also, the position of the intake port 430Yb1 is the same as the position of the intermediate portion 83Y3 of the filter 83Y in the third direction (Y1 direction).

The toner cartridge 430Y has the first frame 430Ya, which forms the toner storage chamber 430Yc as the first chamber together with the filter 83Y. Also, the toner cartridge 430Y has the second frame 430Yb, which forms the air chamber 430Yd as the second chamber together with the filter 83Y, and is joined to the first frame 430Ya. The intake port 430Yb1 is provided in the second frame 430Yb. In the first frame 430Ya, the first flange portion 430Ya2 extending in the direction (X1 direction or Y1 direction) intersecting the first direction is provided at a peripheral edge portion of an opening 430Ya4 that opens in the first direction (Z1 direction) and in a direction facing the second frame 430Yb. In the second frame 430Yb, the second flange portion 430Yb3 extending in the direction (X1 direction or Y1 direction) intersecting the first direction is provided at a peripheral edge portion of an opening 430Yb5 that opens in the first direction (Z1 direction) and in a direction facing the first frame 430Ya. At least a part of the first flange portion 430Ya2 and at least a part of the second flange portion 430Yb3 are joined together. The outer edge portion 83Ya, which is the peripheral edge portion of the filter 83Y, is sandwiched between the first flange portion 430Ya2 and the second flange portion 430Yb3.

In a case in which the toner cartridge 430Y is oriented in a predetermined direction, when viewed in the second direction (X1 direction), the first flange portion 430Ya2 has the first inclined surface 433a that is inclined downward from one end in the third direction (Y1 direction) toward the center portion. The first flange portion 430Ya2 has the second inclined surface 433b that is inclined downward from the other end in the third direction (Y1 direction) toward the center portion.

In a case in which the toner cartridge 430Y is oriented in a predetermined direction, when viewed in the second direction (X1 direction), the second flange portion 430Yb3 has the first inclined surface 443a that is inclined downward from one end in the third direction (Y1 direction) toward the central portion. The second flange portion 430Yb3 has the second inclined surface 443b that is inclined downward from the other end in the third direction (Y1 direction) toward the center portion.

At least one of the first flange portion 430Ya2 and the second flange portion 430Yb3 may have the configuration having the first inclined surface and the second inclined surface.

The image forming apparatus 1 has the image forming portion 40 having the photosensitive drum 4Y on which an electrostatic latent image is formed, and the developing unit 9Y as a developing portion for developing the electrostatic latent image formed on the photosensitive drum 4Y with toner. The image forming apparatus 1 has the supply pipe 444Y, which is a connection portion that is capable of detachably attaching the toner cartridge 430Y thereto and connects the discharge port 430Ya1 of the toner cartridge 430Y to the image forming portion 40. The image forming apparatus 1 has the pump unit 80Y, which is an air supply portion that is connected to an intake port 430Yb1 of the toner cartridge 430Y and is an air supply part for supplying air to the toner cartridge 430Y.

A plurality of toner cartridges can be attached to the image forming apparatus 1 in the third direction (Y direction).

With the above-described configuration, the amount of toner remaining in the toner storage chamber 430Yc without being supplied can be reduced.

### Example 2

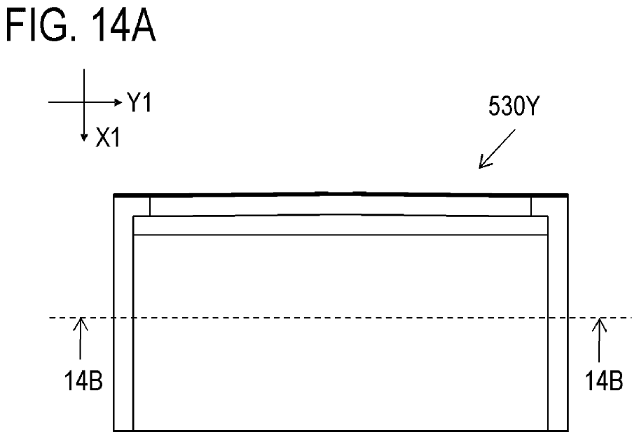

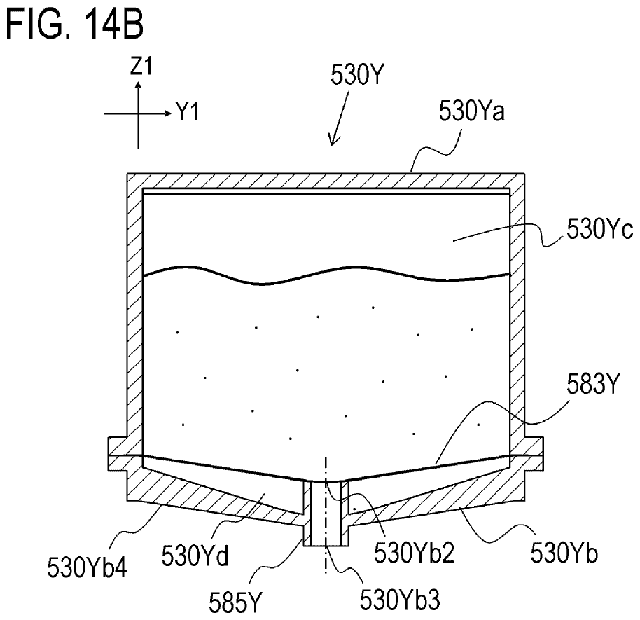

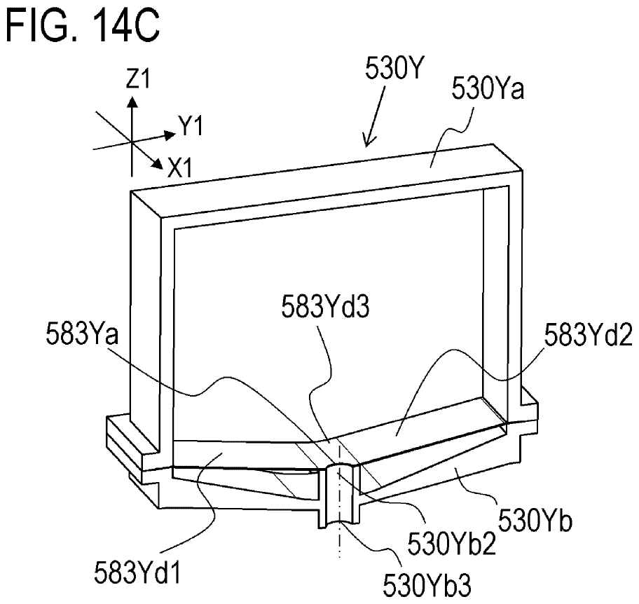

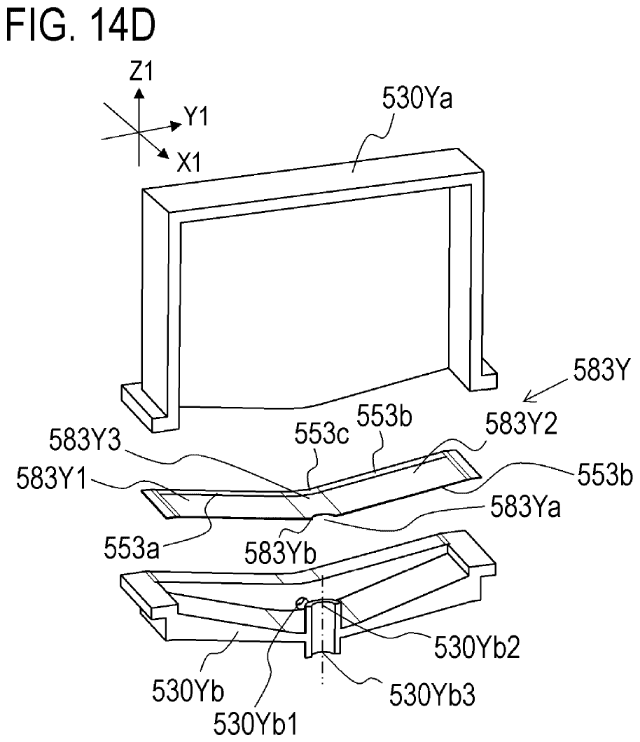

In Example 1, the configuration in which the discharge port of the toner cartridge is provided on the upper surface has been described, but in Example 2, the configuration in which the discharge port is provided on the lower surface will be described with reference to FIGS. 14A to 14D. Also, the same configuration as in Example 1 will be described with the same reference sign in the figures, or will not be illustrated or described.

FIG. 14A is a top view showing a toner cartridge 530Y. FIGS. 14B, 14C, and 14D show cross-sections along line 14B-14B in FIG. 14A, wherein FIG. 14B shows a front view, FIG. 14C is a perspective view, and FIG. 14D is an exploded perspective view.

As shown in FIGS. 14B to 14D, the toner cartridge 530Y has a first frame 530Ya and a second frame 530Yb, and a toner storage chamber 530Yc and an air chamber 530Yd are formed inside. On a back surface of the second frame 530Yb, an intake port 530Yb1 as a container opening that is configured of a through hole penetrating in the X1 direction is provided. Also, on a bottom surface of the second frame 530Yb, a discharge upstream port 530Yb2 and a discharge downstream port 530Yb3 from which the toner in the toner storage chamber 530Yc is discharged to the outside of the toner cartridge 530Y are provided. The discharge upstream port 530Yb2 is connected to a filter 583Y, and the toner in the toner storage chamber 530Yc is discharged to the outside from the discharge downstream port 530Yb3 via a hole 583Ya provided in the filter 583Y. The discharge upstream port 530Yb2 is connected to the lowest portion 583Yb of the filter 583Y. As long as the upstream discharge port 530Yb2 and the filter 583Y can be connected without any gaps, any means such as adhesion or laser welding can be used. Further, in Example 2, the discharge port is formed by the second frame 530Yb, but the discharge pipe may be formed by a filter member if the filter is a member molded from a resin.

In the toner cartridge 530Y of Example 2, the discharge downstream port 530Yb3, which is a discharge port, is provided on a first end surface of the toner cartridge 530Y in the first direction (Z1 direction). When the first direction (Z1 direction) is the direction of gravity and the toner cartridge 530Y is oriented in a predetermined direction in which the toner storage chamber 530Yc is located above the air chamber 530Yd, the first end surface of the toner cartridge 530Y is a bottom surface 530Yb4 thereof. That is, when the toner cartridge 530Y is oriented in a predetermined direction, the discharge downstream port 530Yb3 is provided on the bottom surface 530Yb4 (see FIG. 14B). The filter 583Y is provided with the hole 583Ya, which is a through hole. A discharge pipe 585Y, which is a discharge pipe portion, is provided inside the air chamber 530Yd, which is the second chamber. A downstream end portion of the discharge pipe 585Y in the toner discharge direction is connected to the discharge downstream port 530Yb3, which is a discharge port, and the discharge upstream port 530Yb2, which is an upstream end portion thereof in the discharge direction, is connected to the hole 583Ya of the filter 583Y. The toner cartridge 530Y is configured to be removably attached to the apparatus main body 72 of the image forming apparatus 1, and is attached in the predetermined direction.

When viewed in the second direction (X1 direction), the filter 583Y has, in the third direction (Y direction), a first end portion 583Y1, a second end portion 583Y2 on a side opposite to the first end portion 583Y1, and an intermediate portion 583Y3 between the first end portion 583Y1 and the second end portion 583Y2. The intermediate part 583Y3 has the lowest portion 583Yb. The filter 583Y is provided with a first inclined surface 583Yd1 and a first inclined surface 553a forming a first inclined region that is inclined downward as coming closer to the intermediate portion 583Y3 from the first end portion 583Y1. The filter 583Y is provided with a second inclined surface 583Yd2 and a second inclined surface 553b forming a second inclined region that is inclined downward as coming closer to the intermediate portion 583Y3 from the second end portion 583Y2. The hole 583Ya, which is a through hole, is provided in the intermediate portion 583Y3 of the filter 583Y.

The configuration of Example 2 can discharge the toner in the direction of gravity, and thus, as compared to a configuration in which a discharge pipe is placed with a gap on the upper surface of the filter, it is expected to have the effect of further reducing the amount of toner remaining in the toner container without being supplied.

According to the present disclosure, it is possible to provide a cartridge.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159138, filed on Sep. 13, 2024, which is hereby incorporated by reference herein in its entirety.

What is claimed is:

1. A cartridge comprising:
a first chamber configured to store toner;
a second chamber provided to be aligned with the first chamber in a first direction;
a filter provided to divide the first chamber and the second chamber, the filter allowing passage of air and restricting passage of the toner;
a discharge port configured to discharge the toner stored in the first chamber outside of the cartridge;
an intake port configured to introduce air into the second chamber from outside of the cartridge; and
a discharge pipe portion configured to allow communication between the discharge port and an inside of the first chamber,
wherein the discharge port is provided on a first end surface, which is an end surface of the cartridge in the first direction, and
the intake port is provided on a second end surface, which is an end surface of the cartridge in a second direction intersecting the first direction.

2. The cartridge according to claim 1,
wherein in a case in which the first direction is the direction of gravity and the cartridge is oriented in a predetermined direction in which the first chamber is located above the second chamber,
the first end surface is an upper surface of the cartridge,
the discharge pipe portion is provided inside the first chamber,
a downstream end portion of the discharge pipe portion in a toner discharge direction is connected to the discharge port, and
an upstream end portion of the discharge pipe portion in the discharge direction faces the filter and opens toward the filter.

3. The cartridge according to claim 2,
wherein the discharge pipe portion extends linearly from the filter toward the discharge port.

4. The cartridge according to claim 1,
wherein the cartridge is configured to be removably attachable to an apparatus main body of an image forming apparatus, and
the second end surface is a downstream end surface of the cartridge in a direction in which the cartridge is attached to the apparatus main body.

5. The cartridge according to claim 2,
wherein in the case in which the cartridge is oriented in the predetermined direction, in a case of being viewed in the second direction, the filter includes, in a third direction intersecting the first direction and the second direction, a first end portion, a second end portion on a side opposite to the first end portion, and an intermediate portion between the first end portion and the second end portion,
wherein the filter is provided with a first inclined region and a second inclined region, the first inclined region being inclined downward coming closer to the intermediate portion from the first end portion, the second inclined region being inclined downward coming closer to the intermediate portion from the second end portion, and
wherein the upstream end portion of the discharge pipe portion opens to face the intermediate portion of the filter.

6. The cartridge according to claim 1,
wherein in a case in which the first direction is the direction of gravity and the cartridge is oriented in a predetermined direction in which the first chamber is located above the second chamber,
the first end surface is a bottom surface of the cartridge,
wherein the filter is provided with a through hole,
wherein the discharge pipe portion is provided inside the second chamber,
wherein a downstream end portion of the discharge pipe portion in a toner discharge direction is connected to the discharge port, and
wherein an upstream end portion of the discharge pipe portion in the discharge direction is connected to the through hole of the filter.

7. The cartridge according to claim 6,
wherein in the case in which the cartridge is oriented in the predetermined direction, in a case of being viewed in the second direction, the filter includes, in a third direction intersecting the first direction and the second direction, a first end portion, a second end portion on a side opposite to the first end portion, and an intermediate portion between the first end portion and the second end portion,
wherein the filter is provided with a first inclined region and a second inclined region, the first inclined region being inclined downward as coming closer to the intermediate portion from the first end portion, the second inclined region being inclined downward as coming closer to the intermediate portion from the second end portion, and
wherein the through hole is provided in the intermediate portion of the filter.

8. The cartridge according to claim 1,
wherein the discharge port is provided at a position including a center of the cartridge in the second direction.

9. The cartridge according to claim 5,
wherein a position of the intake port is the same as a position of the intermediate portion of the filter in the third direction.

10. The cartridge according to claim 1,
wherein the cartridge includes a first frame and a second frame, the first frame forming the first chamber together with the filter, the second frame forming the second chamber together with the filter and being bonded to the first frame, and
wherein the intake port is provided in the second frame.

11. The cartridge according to claim 10,
wherein a first flange portion extending in a direction intersecting the first direction is provided at a peripheral edge portion of an opening of the first frame,
wherein a second flange portion extending in a direction intersecting the first direction is provided at a peripheral edge portion of an opening of the second frame, and
wherein at least a part of the first flange portion and at least a part of the second flange portion are joined together.

12. The cartridge according to claim 11,
wherein a peripheral edge portion of the filter is sandwiched between the first flange portion and the second flange portion.

13. The cartridge according to claim 5,
wherein the cartridge is configured to be removably attached to an apparatus main body of an image forming apparatus, and is attached in the predetermined direction.

14. The cartridge according to claim 7,
wherein the cartridge is configured to be removably attached to an apparatus main body of an image forming apparatus, and is attached in the predetermined direction.
